(19) United States
(12) Patent Application Publication
(10) Pub. No.: US 2026/0326255 A1
(43) Pub. Date: Oct. 22, 2026

(54) Systems and Methods of Identifying, Tracking, Evaluating, and Conditioning Percussive Drill Bits

(71) Applicant: Boart Longyear Manufacturing and Distribution, Salt Lake City, UT (US)

(72) Inventors: Karl Ingmarsson, Salt Lake City, UT (US); Jeff Hogan, Brompton (CA)

(21) Appl. No.: 19/110,492

(22) PCT Filed: Sep. 15, 2023
(86) PCT No.: PCT/US2023/032877

§ 371 Date: Mar. 11, 2025

Related U.S. Application Data
(60) Provisional application No. 63/407,458, filed on Sep. 16, 2022.

(51) Int. Cl. B24B 3/33; E21B 10/36; E21B 12/00; G05B 19/4065; G06T 7/00; G06T 7/62

(52) U.S. Cl. CPC B24B 3/33; E21B 10/36; E21B 12/00; G05B 19/4065; G06T 7/0004; G06T 7/62; G05B 2219/45059; G06T 2207/30108

(57) ABSTRACT

Devices, systems, and methods for identifying, tracking, evaluating, and/or conditioning drill bits (e.g., rock drill bits). A computing device can be configured to receive and store data associated with the drill bit. The system can include an imaging device that is in communication with the computing device and configured to acquire at least one image of the drill bit. The computing device and/or a remote computing device in communication with the computing device can store informational profiles associated with respective drill bits, and the imaging device can provide data/information that is used to update or modify the drill bit informational profiles stored by the computing device and/or remote computing device. The drill bit informational profiles can include information that is used to determine reconditioning (e.g., sharpening) steps that will prepare the drill bits for further usage.

### CROSS-REFERENCE TO RELATED APPLICATION

This application claims priority to and the benefit of the filing date of U.S. Provisional Patent Application No. 63/407,458, filed Sep. 16, 2022, the entirety of which is hereby incorporated by reference herein.

### FIELD

This application relates to devices, systems, and methods for identifying, tracking, evaluating, and/or conditioning drill bits (e.g., rock drill bits).

### BACKGROUND

The percussive drilling process in formations involves using a drill string having a drill bit to cut material from a formation (e.g., a rock formation). The drill bit is forced into rock-bit contact through an applied feed force, percussive energy transmitted through the drill string and rotation/indexing. The drill bit is repeatedly percussively forced against the bottom of the borehole to cut the material and thereby increase the depth of the borehole. When rock drill bits are sharp, the percussive energy transferred into the formation is optimized, large chips are produced and penetration rate is maximized. As use progresses areas of the drill bit may incur wear. In one example, flats may develop on the buttons (e.g., tungsten carbide) that make contact with the rock. When flats develop, energy utilization is no longer optimized and can lead to a lower penetration rate and reduced productivity. As buttons wear, the drill bit is less effective at fracturing the formation and the energy is dispersed over a larger area. As the buttons wear and/or are damaged, there is a loss of drilling productivity and an increase in reflective energy. This reflective energy may contribute to increased loads on the tooling, drifter, and rig. When this happens, refurbishing of the buttons and/or refurbishing of the entire drill bit can be performed to provide maximum drill bit utilization, to maintain both penetration and productivity, and extend the life of all drill string components. In addition, severely worn or flattened buttons frequently also fracture, a problem which can be reduced with periodic refurbishing.

Conventionally, drill bits are subjected to manual inspection by drill rig operators, and the drill bits are used (often in multiple drilling operations) until either a defective condition is observed, or poor performance is observed during a drilling operation. Drill rig operators typically do not have access to the information concerning the historical usage of the drill bit that they are using.

Refurbishment of rock drill bits often includes grinding the carbide buttons to remove or minimize the flats and reshaping them back closer to their original profile. Depending on the degree of wear, this refurbishment of rock drill bits may be performed multiple times over the lifespan of a drill bit. Developing more advanced methods for minimizing the amount of material removed during the refurbishing process may lead to an increase in the number of times a drill bit can be refurbished and subsequently an increase in the lifespan of the drill bit. Drilling operations utilize a stock of rock drill bits that may be used to swap out worn bits for sharp bits such that drilling may continue. The worn bits are sent for reconditioning while the remaining stock bits are utilized. It is beneficial to the uninterrupted flow of mining operators to know not only the number of rock drill bits they have in stock but also the remaining life span of rock drill bits they have had reconditioned. This would allow operators to properly adjust their stock to ensure drilling can be continued uninterrupted without stock issues. Although wear is the most common issue, buttons may be damaged or missing for other reasons. Regardless of reason, the state of bits each bit must be assessed prior to being further used. As bits wear, the effective drilling diameter is reduced to a point where they no longer meet the requirements of the application and must be discarded.

Therefore, percussive drilling operations could benefit from a system capable of evaluating a drill bit condition. Percussive drilling operations could also benefit from a system capable of identifying and tracking usage of a particular drill bit over time. Still further, percussive drilling operations could benefit from systems and methods that establish a reconditioning program to optimize performance and overall life of a drill bit. It would further be beneficial to have a system that was capable of evaluating a bit condition, and establishing a reconditioning program to optimize performance and overall life based on the evaluation of bit condition. Still further, it would be beneficial to provide data that can be used to track and improve drill bit performance. For example, such data can include rock bit design, operational parameters (such as rotation, percussive power, or collaring practices), rig and drifter type and condition, operator behavior and practices, as well as geology or mining area.

### SUMMARY

Described herein, in various aspects, are systems and methods for identifying, tracking, evaluating, and/or conditioning drill bits (e.g., percussive rock drill bits, such as down-the-hole percussive bits or top hammer bits). In some aspects, the disclosed systems and methods can allow for tracking of a drill bit informational (usage/wear/conditioning) profile over time, thereby allowing for and/or directing informed decisions concerning the suitability of drill bits for particular drilling operations. The disclosed systems and methods can further allow for and/or direct reconditioning of drill bits when appropriate or necessary for a particular drilling operation. The disclosed systems and methods can further provide an indication of when a drill bit has no remaining useful life.

Described herein, in various aspects, is a system having a computing device in communication with an imaging device. The computing device can be configured to receive and store data associated with the drill bit. The imaging device can be configured to acquire at least one image of the drill bit. The system can further include a reader in communication with the computing device. The reader can be configured to detect an identifier associated with a drill bit. The identifier can be indicative of an identity of the drill bit. For example, the identifier can include or be indicative of a serial number of the drill bit. The computing device can be configured to receive an input from the reader that corresponds to the identifier associated with the drill bit. Optionally, the system can include a drill bit sharpening apparatus that is in communication with the computing device. Optionally, the system can include a drill rig controller that is in communication with the computing device. The computing device and/or a remote computing device in communication with the computing device can store informational profiles associated with respective drill bits, and the various system components (imaging device, drill bit sharpening apparatus, and/or drill rig controller) can provide data/information that is used to update or modify the drill bit informational profiles stored by the computing device and/or remote computing device. Methods of using the disclosed system are also described.

In additional aspects, a system can include an imaging device and a computing device in communication with the imaging device. The imaging device can be configured to acquire at least one image of a face portion of a drill bit, with the face portion of the drill bit having a face surface and a plurality of buttons projecting from the face surface. The computing device can be configured to determine or update an informational profile of the drill bit based upon the at least one acquired image. As further disclosed herein, the informational profile of the drill bit can include information indicative of the physical structure, wear, historical usage, conditioning, and/or other parameters associated with the drill bit. Optionally, the computing device can be configured to produce (e.g., generate) a three-dimensional representation of the face portion of the drill bit based at least in part on the at least one acquired image of the face portion of the drill bit, and the three-dimensional representation of the face portion of the drill bit can be used to determine or update the informational profile of the drill bit. The informational profile of the drill bit can include wear related volumetric loss information (e.g., measured wear flats), and the computing device can be configured to determine, based on the measured wear flats, a determined amount of button material to be removed at one or more buttons of the plurality of buttons of the drill bit. Optionally, the system can include a drill bit sharpening apparatus in communication with the computing device, and the computing device is configured to determine, based on the determined amount of button material to be removed at each of the one or more buttons, optimal grinding parameters (e.g., an optimal grinding duration) for each of the one or more buttons. Optionally, based on the at least one image, the computing device can be configured to determine a gauge diameter of the drill bit and a need for subjecting the drill bit to a steel removal process. Optionally, the system can include a marking apparatus that is in communication with the computing device and configured to receive an input from the computing device that is indicative of a determined gauge diameter of the drill bit. In use, the marking apparatus can be configured to apply a mark or color to the drill bit based on the determined gauge diameter of the drill bit. Methods of using the disclosed system are also described.

In additional aspects, a system can include an imaging device configured to acquire data associated with a face portion of a drill bit, the face portion of the drill bit having a face surface and a plurality of buttons projecting from the face surface. The system can further include a computing device in communication with the imaging device. The computing device can be configured to: receive data associated with the face portion of the drill bit from the imaging device; and determine, based on the data received from the imaging device, an informational profile of the face portion of the drill bit, wherein the informational profile includes geometric, wear, usage, and/or condition information.

Additional advantages of the disclosed apparatuses, systems, and methods will be set forth in part in the description that follows, and in part will be obvious from the description, or may be learned by practice of the invention. The advantages of the disclosed apparatuses, systems, and methods will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

These and other features of the preferred embodiments of the disclosed apparatuses, systems, and methods will become more apparent in the detailed description in which reference is made to the appended drawings wherein:

FIG. 1 is an illustration of a system for reconditioning rock drill bits and tracking inventory in accordance with embodiments disclosed herein.

FIG. 2 is a perspective view of a drill bit for use in the system for reconditioning rock drill bits and tracking inventory illustrated in FIG. 1.

FIG. 3 is an illustrative detail showing button wear vs recommended maintenance on rock drill bits such as the drill bit shown in FIG. 2.

FIG. 4 is a schematic side view of a drill bit button illustrating a button wear zone and an exemplary minimum button face material removal profile for a single button of the drill bit shown in FIG. 2.

FIG. 5 is a side view schematic illustration of a drill bit button illustrating button wear, an overlay comparison of a current button geometry/structure with a historical button geometry/structure (based on at least one historical scan), and the determined minimum button face material removal profile for the button.

FIG. 6 is a schematic illustration of an exemplary bit grinder assembly as shown in FIG. 1, with the grinder assembly shown removing face material from a button of a drill bit as disclosed herein.

FIG. 7 is a schematic illustration of an exemplary bit grinder assembly as shown in FIG. 1, with the bit grinder assembly shown removing face material from a button of a drill bit as disclosed herein.

FIG. 8 is a flow chart illustrating an exemplary method of drill bit reconditioning in accordance with the embodiments disclosed herein.

FIG. 9 is a flow chart illustrating an additional aspect of an exemplary method of drill bit reconditioning in accordance with the embodiments disclosed herein.

FIG. 10 is a flow chart illustrating an additional aspect of an exemplary method of drill bit reconditioning in accordance with the embodiments disclosed herein.

FIG. 11 is a flow chart illustrating an additional aspect of a method of drill bit reconditioning and inventory tracking that may be utilized along with any of the various methods described herein.

FIG. 12 is a flow chart illustrating an additional aspect of a method of drill bit reconditioning and inventory tracking that may be utilized along with any of the various methods described herein.

FIG. 13 is a flow chart illustrating an additional aspect of a method of drill bit reconditioning and inventory tracking that may be utilized along with any of the various methods described herein.

FIG. 14 a flow chart illustrating an additional aspect of a method of drill bit reconditioning and inventory tracking that may be utilized along with any of the various methods described herein.

FIG. 15 a flow chart illustrating an additional aspect of a method of drill bit reconditioning and inventory tracking that may be utilized along with any of the various methods described herein.

FIG. 16 is an additional aspect of a method of drill bit reconditioning and inventory tracking in accordance with the embodiments disclosed herein.

FIG. 17 is an additional aspect of a method of drill bit reconditioning and inventory tracking in accordance with the embodiments disclosed herein.

FIG. 18 is a schematic diagram depicting an exemplary system as disclosed herein.

FIG. 19 is a schematic diagram depicting an exemplary system as disclosed herein.

FIG. 20A is a schematic diagram depicting an exemplary server in communication with other computing devices as disclosed herein. FIG. 20B is a schematic diagram depicting an existing machine learning system as disclosed herein.

FIG. 21 is a flowchart depicting an exemplary training method as disclosed herein.

FIG. 22 is a schematic diagram depicting an exemplary environment for training a machine learning classifier as disclosed herein.

FIG. 23 is a flowchart depicting an exemplary method for determining a condition of a drill bit as disclosed herein.

FIG. 24 is a flow chart depicting an exemplary method for determining a quantity of material to be removed from buttons of a drill bit as disclosed herein.

FIG. 25 is a flow chart depicting an exemplary method for determining one or more condition signatures of a drill bit as disclosed herein.

FIG. 26 is a flow chart depicting an exemplary method for determining if a drill bit has been properly run as disclosed herein.

FIG. 27 shows a grinder grinding a drill bit in accordance with embodiments disclosed herein.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” include plural referents unless the context clearly dictates otherwise. For example, use of the term “a button” can represent disclosure of embodiments where only a single button is provided, as well as embodiment sin which a plurality of such buttons are provided. Similarly, the term “a computing system” can refer to any system comprising any number of processors and memory storage devices, operating serially and/or in parallel to achieve the operability and configurations described and claimed herein.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

Ranges can be expressed herein as from “approximately” one particular value, and/or to “approximately” another particular value. When such a range is expressed, another aspect includes from the one particular value and/or to the other particular value. Similarly, when values are expressed as approximations, by use of the antecedent “approximately,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “approximately,” it is contemplated that values within up to 15%, up to 10%, up to 5%, or up to 1% (above or below) of the particularly stated value can be included within the scope of those aspects.

Unless context dictates otherwise, the word “or” as used herein means any one member of a particular list and also includes any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

### Systems and Methods for Identifying and Tracking Individual Drill Bits

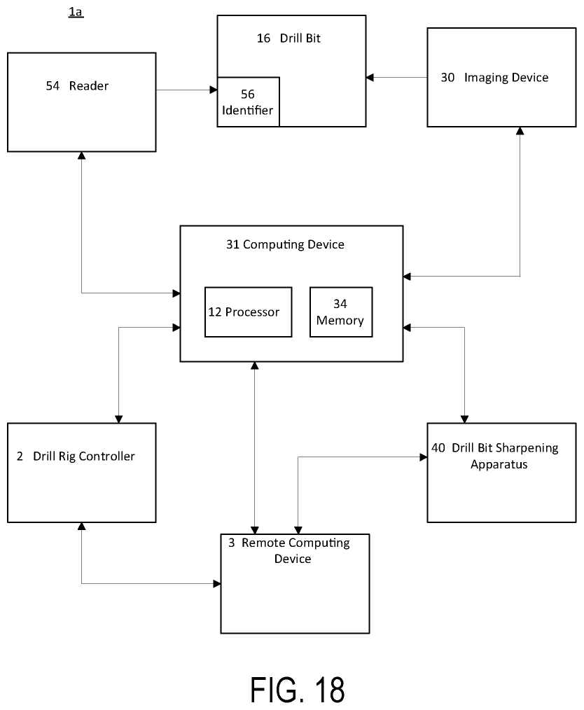

Disclosed herein, in various aspects, and with reference to FIG. 18, are systems and methods for identifying and associating data with drill bits (e.g., rock drill bits). The drill bit can comprise a face portion. The face portion of the drill bit can have a face surface and a plurality of buttons projecting from the face surface. In exemplary aspects, the buttons can comprise a material (e.g., tungsten carbide) that is harder than the material defining the face surface of the face portion of the drill bit. In exemplary aspects, a system la can comprise a reader 54 configured to detect an identifier 56 associated with a drill bit 16. In these aspects, the identifier 56 can be indicative of an identity of the drill bit 16. For example, the identifier 56 can optionally comprise a serial number associated with the drill bit. In other aspects, it is contemplated that the identifier 56 can comprise a code (e.g., barcode, QR code, and the like), an identification tag (e.g., radiofrequency identification tag), or other feature that is configured to be detected (e.g., scanned) or identified by the reader 54, which in some example configurations can be an optical scanner, an RFID reader, or a camera as is known in the art.

A computing device 31 can be in communication with the reader 54 and configured to receive an input from the reader that corresponds to the identifier 56 associated with the drill bit 16. As further disclosed herein, the computing device 31 can be configured to receive and store data associated with the drill bit 16. In exemplary aspects, the computing device 31 can comprise a memory 34 that stores data associated with the drill bit. Additionally, or alternatively, the system la can comprise a remote database that stores data with the drill bit and that is communicatively coupled to the computing device 31 (and, optionally, other elements of the system 1a).

In some aspects, the computing device 31 can be configured to permit, via a user interface, input of the identifier. For example, the computing device 31 can provide, on the user interface, a menu (e.g., a drop-down menu) that permits selection of the identifier 56.

Optionally, the system la can further comprise an imaging device 30 (e.g., a camera or image scanner) that is in communication with the computing device 31, wherein the imaging device is configured to acquire at least one image of the drill bit 16, or an image of a face portion of the drill bit 16. In exemplary aspects, the at least one image can comprise at least one two-dimensional image. In other aspects, it is contemplated that the at least one image can comprise at least one three-dimensional image or scan (e.g., a point cloud). Additionally, or alternatively, in still further aspects, it is contemplated that the imaging device 30 and/or the computing device 31 can be configured to convert data (e.g., image data, pixel data, point cloud data, etc.) acquired by the imaging device into a tabulated description that corresponds to the at least one image of the drill bit 16. For example, the tabulated description can include, for example, a type of bit (e.g., a particular model, part number, design, SKU), an identity of the particular bit, an amount of wear on each button, identified buttons that are missing, and/or a remaining gauge diameter of the bit. The type of bit can be determined, for example, by identifying a number of buttons and their relative positions on the face portion of the drill bit.

In some aspects, the computing device 31 can be configured to receive data associated with the face portion of the drill bit from the imaging device. For example, the computing device 31 can receive the at least one image of the drill bit 16 (e.g., an image of the face portion of the drill bit 16). In other aspects, the computing device 31 can receive data based on the at least one image of the drill bit 16 (e.g., data associated with the tabulated description of the drill bit). In further aspects, the computing device 31 can be configured to determine, based at least in part on the acquired at least one image of the drill bit 16, a condition and/or attribute of the drill bit. For example, the computing device 31 can comprise a processor 12 in communication with a memory 34. The processor 12 of the computing device 31 can be configured to determine one or more characteristics of a face portion 21 of the drill bit 16 based on the at least one image of the drill bit. As an example, the processor 12 can be configured to determine, based on the at least one image of the drill bit 16, dimensions, relative dimensions, shapes, and/or defects of respective portions of the drill bit (such as, for example, buttons and/or gauge portions of the bit).

It is further contemplated that the identifier 56 can be associated with the geometry of the drill bit. For example, the computing device 31 can be configured to determine the identity of the drill bit based on the data received from the imaging device. In some aspects, the geometry of the drill bit that provides the identifier of the drill bit can comprise a number of buttons, locations of the plurality of buttons, and/or sizes of the plurality of buttons. Accordingly, the computing device 31 can determine the identity of the drill bit based on the image or other data associated with the face portion of the drill bit from the imaging device. Optionally, the identifier 56 can comprise a general identifier that is specific to the general geometry of a group of related bits (e.g., bits having the same part number). In other aspects, the identifier 56 can be specific to the particular bit. In some aspects, the computing device 31 can determine the identity of the drill bit based on the image or other data associated with the face portion of the drill bit from the imaging device by comparing the image or other data with a CAD (computer-aided design) drawing or geometry from an image (e.g., 3D scan) in memory. In aspects in which a particular bit does not have a pre-existing profile, the computing device can create a new profile based at least in part on a reference image. The reference image can be an initial image or a CAD file.

In exemplary aspects, it is contemplated that the imaging device 30 (e.g., a smartphone camera) can acquire a plurality of two-dimensional images of the drill bit 16, with at least one of the images being a full 90 degrees frontal view. In these aspects, the plurality of two-dimensional images can be stored in the memory 34 or a remote database and included in an informational profile associated with the drill bit. In further aspects, it is contemplated that the computing device 31 can be configured to apply image recognition techniques to determine usage and/or geometric/structural information for inclusion in an informational profile of the drill bit. In these aspects, the computing device 31 can be configured to determine a presence of one or more condition signatures within the plurality of two-dimensional images. The one or more condition signatures can each be indicative of a condition associated with information stored in the informational profile of the drill bit. For example, it is contemplated that the computing device 31 can be configured to estimate dimensions and/or orientations of wear flats on the buttons of the drill bit based on the two-dimensional images (which indicate am amount of material loss). In other exemplary aspects, the one or more condition signatures can be indicative of one or more of: broken buttons; lost or missing buttons; over-drilled buttons; portions of the bit body (that supports the buttons) contacting rock (or other formation material); insufficient rotation speed; or excessive rotation speed. In further aspects, the one or more condition signatures can be indicative of under-drilling or a properly-worn bit. In further exemplary aspects, the computing device can be configured to determine, based upon the one or more condition signatures and the plurality of two-dimensional images, characteristics of a previous drilling cycle of the drill bit. Optionally, in these aspects, the characteristics of the previous drilling cycle of the drill bit can include a determination of whether the drill bit was operated improperly during the previous drilling cycle. In further aspects, the characteristics of the previous drilling cycle of the drill bit can include a determination of whether the drill bit was damaged despite being operated properly during the previous drilling cycle. In still further aspects, the computing device can be configured to associate the characteristics of the previous drilling cycle with one or more of: a drill operator who participated in the previous drilling cycle; a drill rig that performed the previous drilling cycle; and/or a client account. In exemplary aspects, the computing device can be configured to provide, based on the one or more condition signatures, an output (e.g., a textual or visual output) indicative of recommended modifications to the structure (e.g., sharpening or steel removal) or usage (e.g., normal use, limited use, or retirement) of the drill bit to provide operational improvements.

In some aspects, as further disclosed herein, the computing device can be configured to determine a condition of the drill bit. In these aspects, it is contemplated that the condition of the drill bit can be assigned a category indicative of determined physical, wear, damage, or usage properties of the drill bit. Optionally, in these aspects, it is contemplated that the images of the drill bit can be discarded, and the categorization information can be stored.

In exemplary aspects, the computing device 31 can comprise or be communicatively coupled to a machine learning model as further disclosed herein. It is contemplated that the machine learning model can analyze one or more images of the drill bit and determine a condition and/or attribute of the drill bit. For example, the machine learning model can use a segmentation model to classify individual pixels or clusters of pixels within the image as corresponding to or not corresponding to one or more physical features associated with the drill bit. A visible output (image, text, graphic, or combination thereof) indicative of the identified physical features (and the condition of the drill bit) can be displayed (e.g., provided) at a user interface. Optionally, the user interface can allow a user to modify, edit, save, and/or send the output.

Optionally, in some aspects, the imaging device 30 can be configured to receive an input from the computing device 31 that corresponds to the identifier 56 associated with the drill bit 16. In these aspects, based on the input from the computing device 31 and the acquired at least one image of the drill bit 16, the imaging device 30 can be configured to produce a three-dimensional representation of the drill bit. As an example, the imaging device 30 can comprise or be in communication with a memory that stores a plurality of three-dimensional representations (e.g., images, graphical representations, tabulated representations reflecting three-dimensional properties, text-based descriptions reflecting three-dimensional properties) associated with respective serial numbers, model numbers, SKUs (or other identifiers) of drill bits. In this example, a imaging device 30 can comprise or be in communication with a processor that is configured to determine a three-dimensional representation of the plurality of three-dimensional representations that corresponds to the detected serial number (or other detected identifier) of the drill bit. Optionally, in these examples, it is contemplated that the memory 34 of the computing device 31 can store the plurality of three-dimensional representations, and the processor 12 of the computing device 31 can determine the three-dimensional representation that corresponds to the detected identifier. However, it is further contemplated that the memory and processor can be components of the imaging device 30 and/or a remote computing device. As further disclosed herein, it is contemplated that the three-dimensional representation can comprise images, graphical representations, tabulated representations reflecting three-dimensional properties, text-based descriptions reflecting three-dimensional properties, or combinations thereof.

Optionally, in some aspects, the system 1a can further comprise a drill bit sharpening apparatus 40 in communication with the computing device 31. In these aspects, the drill bit sharpening apparatus 40 can be configured to receive an output from the computing device 31 that is indicative of the identifier 56 associated with the drill bit 16. In use, it is contemplated that the drill bit sharpening apparatus 40 can be configured to update a stored informational profile associated with the drill bit (or to provide outputs to the computing device 31 sufficient to update the stored informational profile) to include information associated with the sharpening of the drill bit, such as, for example, an updated count of total sharpening processes that have been performed on the drill bit. In further aspects, it is contemplated that the drill bit sharpening apparatus 40 can be configured to update the stored informational profile associated with the drill bit (or to cause the computing device 31 to update the stored informational profile) to include information about the amount of material that is removed from the drill bit in a given sharpening process or a total amount of material that has been removed from the drill bit over the course of a life of the drill bit.

Optionally, in some aspects, the system la can further comprise a drill rig controller 2 in communication with the computing device 31. In these aspects, the drill rig controller 2 can be configured to control operation of a drill rig, including, for example, the control of percussive drilling operations using drill bits as disclosed herein. In exemplary aspects, the reader 54 can be a component of or positioned in proximity to the drill rig that is controlled by the drill rig controller 2. In some aspects, the computing device 31 can be configured to generate a time stamp corresponding to a time of a detection (by the reader 54) of the identifier 56 associated with the drill bit 16. In these aspects, it is contemplated that the drill rig controller 2 can be configured to provide one or more inputs to the computing device 31 that are indicative of drilling information as further disclosed herein. In further aspects, the drill rig controller 2, the computing device 31, or a remote computing device 3 can be configured to determine a number of meters drilled by the drill bit. For example, based on information provided to the drill rig controller, the computing device, or the remote computing device concerning a number of drill rods used during a drilling operation and/or depth (or change in depth) associated with a drilling operation, the drill rig controller, the computing device, or the remote computing device can determine the number of meters drilled by the drill bit. In further aspects, the drill rig controller 2, the computing device 31, or the remote computing device 3 can be configured to update a stored informational profile associated with the drill bit to reflect the determined number of meters drilled by the drill bit. In further aspects, the drill rig controller 2, the computing device 31, or the remote computing device 3 can be configured to update a stored informational profile associated with the drill bit 16 to indicate a total number of times the drill bit has been used in a drilling operation (e.g., the number of times the drill bit has been installed on a rig). For example, the stored informational profile associated with the drill bit can include an indication of the total number of drilling operations performed using the drill bit, and upon completion of a drilling operation using a previously identified drill bit, the drill rig controller can be configured to increase the number of drilling operations associated with the informational profile of the drill bit.

In exemplary aspects, the system la can further comprise a remote computing device 3 that can be communicatively coupled (e.g., wirelessly communicatively coupled) to one or more of the computing device 31, the drill bit sharpening apparatus 40, and/or the drill rig controller 2. For example, it is contemplated that the remote computing device 3 can store informational profiles associated with respective drill bits, and the computing device 31, the drill bit sharpening apparatus 40, and/or the drill rig controller 2 can be configured to provide data or other information to the remote computing device 3 that can be used to update the informational profiles associated with the corresponding drill bits. In some aspects, the computing device 31 can store the informational profiles associated with the drill bits, and the computing device 31 can transmit the stored informational profiles (and updates to the stored informational profiles) to the remote computing device 3, which can in turn be accessed by other computing devices on a network.

As further described below, various operations of the disclosed system la can be performed on a network that employs machine learning techniques to determine information (e.g., usage, conditioning, wear, and/or structural information) to be included in drill bit informational profiles, optimal button material removal, and/or characteristics of previous runs of a drill bit.

### Systems and Methods for Evaluating, Conditioning, and Tracking Drill Bits

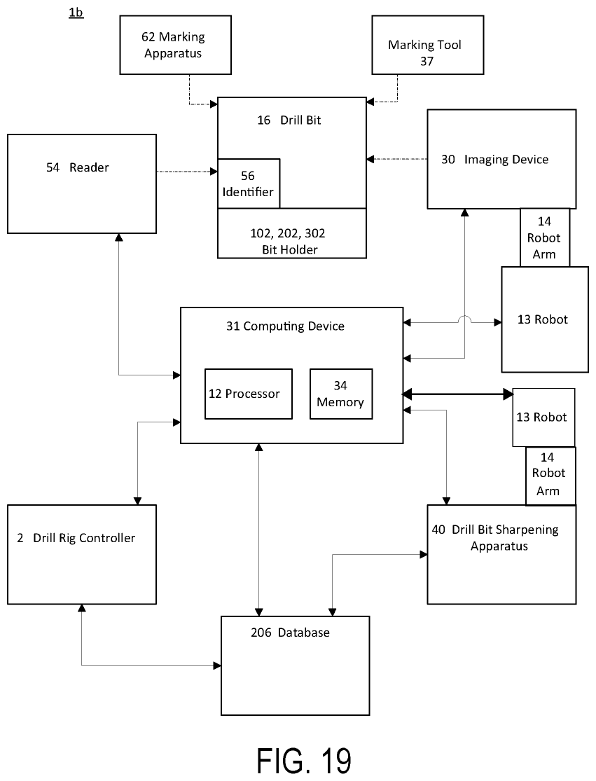

In exemplary aspects, and with reference to FIG. 19. a system 1b can comprise an imaging device 30 configured to acquire at least one image of a face portion 21 of a drill bit 16. As further disclosed herein, the face portion 21 of the drill bit 16 can have a face surface 22 and a plurality of buttons 24 projecting from the face surface. In these aspects, the system 1b can further comprise a computing device 31 in communication with the imaging device 30. Optionally, it is contemplated that the computing device 31 can be configured to produce a three-dimensional representation of the face portion 21 of the drill bit 16 based at least in part on the at least one acquired image of the face portion of the drill bit. The computing device 31 can be further configured to determine information (e.g., usage, structural/geometric, condition, and/or wear information) for inclusion in an informational profile of the drill bit 16 based upon the at least one image (and, optionally, the three-dimensional representation of the face portion of the drill bit). As further disclosed herein, it is contemplated that the three-dimensional representation can comprise images, graphical representations, tabulated representations reflecting three-dimensional properties, text-based descriptions reflecting three-dimensional properties, or combinations thereof.

In exemplary aspects, the informational profile of the drill bit 16 can include wear-related volumetric loss information, such as for example, measured wear flats. The computing device 31 can be configured to determine, based on the wear-related volumetric loss information (e.g., measured wear flats), a determined amount of button material to be removed at one or more buttons 24 of the plurality of buttons of the drill bit 16. As can be understood, the wear-related volumetric loss information (reflecting an amount of lost material) can be determined by the computing device based upon an analysis of two-dimensional images and/or three-dimensional representations as further disclosed herein. In some aspects, the computing device 31 can be configured to determine optimal shapes for the plurality of buttons 24. In these aspects, the computing device can be configured to determine an amount of button material to be removed to produce the optimal shapes for one or more buttons of the plurality of buttons. In some exemplary aspects, the wear-related volumetric loss information can be indicative of or reflect chipped buttons, buttons having sheared-off portions, and/or other partially damaged buttons. In such aspects, it is contemplated that the determined amount of button material to be removed can be based upon wear-related volumetric loss (e.g., measured wear flats), along with information indicative of the amount of damage to the button. In various aspects, wear-related volumetric loss information can comprise a linear dimension (e.g., height change of a button), volumetric dimension (e.g., volume change of a button), gauge diameter loss, or a generalized category (e.g., low, medium, or high volumetric loss). In further aspects, volumetric loss can be associated with wear, damage, or complete detachment of one or more buttons.

In some aspects, the determined amount of button material to be removed can be an amount of button material to be removed from each button of the plurality of buttons so that each button has a predetermined profile. The predetermined profile can be, for example, the profile of the button prior to use, or a preferred shape of the button. In other aspects, the determined amount of button material to be removed can be a respective amount of button material to be removed from each button of the plurality of buttons, limited by at least one specification of the drill bit. The specification of the drill bit can include, for example, a minimum tolerated gauge diameter at which the drill bit is usable. Removal of the determined amount of button material can be configured to retain a gauge diameter greater than or equal to the minimum tolerated gauge diameter, thereby permitting further use of the drill bit before the drill bit reaches the minimum tolerated gauge diameter. Accordingly, in some aspects, the buttons may not be fully sharpened, or otherwise shaped according to a predetermined profile. Rather, a lack of sufficient material of the buttons to provide minimum tolerated gauge diameter if completely sharpened can instead lead to removing button material only to provide the minimum tolerated gauge diameter. The minimum tolerated gauge diameter can be determined based on the intended use of the drill bit. For example, bits for blasthole drilling and bits for bolting drilling can have different minimum tolerated gauge diameters. Thus, in various aspects, the computing device can be configured to determine the amount of button material to be removed to provide a fully sharpened button, a partially sharpened button, or a unique height for a specific button.

In various aspects, the determined amount of button material to be removed at one or more buttons of the plurality of buttons of the drill bit can be an equal amount to be removed from each button of the plurality of buttons. In alternative aspects, the determined amount of button material to be removed at one or more buttons of the plurality of buttons of the drill bit can vary for each button of the plurality of buttons. For example, in some aspects, the drill bit can comprise a plurality of face buttons and a plurality of gauge buttons. In some aspects, the gauge buttons can wear faster than the face buttons. Optionally, in these aspects, the determined amount of button material to be removed at one or more buttons of the plurality of buttons of the drill bit can be an equal amount to be removed from each button of the plurality of face buttons. In still further aspects, the determined amount of button material to be removed at one or more buttons of the plurality of buttons of the drill bit can vary between gauge buttons and between face buttons.

In some aspects, the computing device can be configured to determine the amount of button material to be removed at one or more buttons of the plurality of buttons by: determining, based on the data associated with the face portion of the drill bit from the imaging device, portions of the bit corresponding to the plurality of buttons; and determining an amount of material loss of each button of the at least one button due to wear.

In some exemplary aspects, the system can further comprise a drill bit sharpening apparatus 40 in communication with the computing device 31. In these aspects, the computing device 41 can be configured to determine, based on the determined amount of button material to be removed at each of the one or more buttons 24, optimal grinding parameters (e.g., an optimal grinding duration) at each of the one or more buttons.

In exemplary aspects, it is contemplated that the computing device 31 can be configured to determine a minimum amount of material that should be removed for each sharpening procedure, thereby maximizing the gauge diameter following each sharpening. In further aspects, it is contemplated that the computing device 31 can be configured to determine an optimal button height to be achieved following sharpening. For example, in these aspects, even if a button has a desired shape after grinding, excessive protrusion of the button above the supporting drill bit body can lead to decreases in durability (shear, pop-outs). Therefore, it is contemplated that the computing device can determine a minimum amount of material that can be removed while achieving a desired button shape and a desired button height.

In some exemplary aspects, the computing device 31 can be configured to determine the amount of button material to be removed at each of the one or more buttons based on a minimum tolerated gauge diameter at which the drill bit is usable. In these aspects, it is contemplated that removal of the determined amount of button material can be configured to retain a gauge diameter greater than the minimum tolerated gauge diameter, thereby permitting further wear of the drill bit before the drill bit reaches the minimum tolerated gauge diameter. In another aspect, the computing device can be configured to determine the amount of button material to be removed based upon a target gauge diameter. In this aspect, it is contemplated that removal of the determined amount of button material can be configured to provide the target gauge diameter.

As can be appreciated, in some aspects, the minimum tolerated gauge diameter can be determined and reevaluated at each sharpening event. For example, during drilling, as buttons wear or break, the gauge diameter can drop below a tolerated gauge diameter, and this cannot be reevaluated until the next sharpening process.

In further aspects, it is contemplated that the disclosed systems and methods can in some applications and conditions be used to sharpen buttons to a shape that does not restore the button to a normal profile (e.g., by purposefully under-sharpening). In these aspects, it is contemplated that such bits can be uniquely identified, through color coding or similar, in order to drill them to destruction.

In some exemplary aspects, the stored informational profile can comprise forward and radial protrusion measurements of each button 24 of the plurality of buttons. In these aspects, the computing device 31 can be configured to determine, based on the forward and radial protrusion measurements of each button of the plurality of buttons, an optimal forward and radial protrusion measurement that is common to each button of the plurality of buttons. The computing device 31 can be further configured to cause the drill bit sharpening apparatus 40 to remove sufficient material of each button 24 of the plurality of buttons such that each button has the optimal forward and radial protrusion measurements.

In further aspects, prior to removal of material from the face portion 21 of the drill bit, the computing device 31 can be configured to determine a gauge diameter of the drill bit 16 and a need for subjecting the drill bit to a steel removal process. The steel removal process can include, for example, steel removal to reduce the gauge diameter of the steel body; or steel removal to increase the effective protrusion of the buttons from the face. Optionally, the computing device 31 can be configured to determine the need for subjecting the drill bit to a steel removal process by comparing the at least one image to an optimal face geometry associated with the drill bit. Optionally, the computing device 31 can be configured to determine a category (e.g., duration) of steel removal (e.g., acid bath steel removal) to which the drill bit should be subjected. For example, in some aspects, the computing device can be configured to determine an optimal category from among a plurality of categories, with each category being associated with a different duration of acid bath (e.g., no acid bath; a short duration of acid bath; a medium duration of acid bath; or a long duration of acid bath). Optionally, it is contemplated that the computing device 31 can determine the gauge diameter based on the same image(s) that are used to determine optimal button removal profiles and parameters. Alternatively, it is contemplated that additional images can be used to permit determination of the gauge diameter. In still further aspects, following steel removal and/or button removal as further disclosed herein, it is contemplated that the reconditioned drill bit can be subjected to additional imaging to allow the computing device to confirm that an optimal gauge diameter and button profile/geometry is achieved.

In additional aspects, the stored informational profile of the drill bit 16 can comprise one or more failure codes, and the computing device can be configured to associate the one or more failure codes with one or more measured parameters or attributes of the drill bit (e.g., the measured gauge diameter of the drill bit).

In further aspects, the system can further comprise a marking apparatus 62 that is in communication with the computing device 31 and configured to receive an input from the computing device that is indicative of a determined gauge diameter of the drill bit 16. In these aspects, following conditioning of the drill bit face as disclosed herein, the marking apparatus 62 can be configured to apply a mark or color to the drill bit 16 based on the determined gauge diameter of the drill bit. For example, the mark or color can be indicative of the approximate gauge diameter of the drill bit, which can be useful to drill operators when determining the remaining useful life of a drill bit and selecting the drill bits to be used in a particular drilling operation.

In exemplary aspects, the computing device 31 can be configured to associate the determined gauge diameter of the drill bit 16 with an identity of the drill bit. Thus, in these aspects, a central database including drill bit information can be updated to reflect updated information concerning the wear level of the drill bit.

In exemplary aspects, the computing device 31 can be configured to determine a presence of one or more condition signatures within the at least one acquired image and/or the three dimensional representation of the drill bit. In these aspects, it is contemplated that the one or more condition signatures can each be indicative of a condition associated with the information in the stored informational profile of the drill bit 16. Optionally, it is contemplated that the one or more condition signatures can be indicative of one or more of: broken buttons; lost or missing buttons; over-drilled buttons; portions of the bit body (that supports the buttons) contacting rock (or other formation material); insufficient rotation speed; or excessive rotation speed. In exemplary aspects, the computing device 31 can be configured to determine, based upon the one or more condition signatures and the at least one acquired image and/or the three-dimensional representation of the drill bit, characteristics of a previous drilling cycle of the drill bit 16. Optionally, in these aspects, the characteristics of the previous drilling cycle of the drill bit can include a determination of whether the drill bit was operated improperly during the previous drilling cycle. For example, the characteristics of the previous drilling cycle of the drill bit can include a determination of whether the drill bit was damaged despite being operated properly during the previous drilling cycle. In another aspect, the computing device 31 can be configured to associate the characteristics of the previous drilling cycle with one or more of: a drill operator who participated in the previous drilling cycle; a drill rig that performed the previous drilling cycle; and/or a client account.

In further exemplary aspects, the system 1b can further comprise a database 206 in communication with a processor 12 of the computing device 31. In these aspects, the database 206 can comprises images of drill bits that have been classified as properly run or improperly run, and the computing device can be configured to determine, based upon the at least one acquired image, whether the drill bit was properly run or improperly run during a previous drilling cycle. For example, in some aspects, the computing device 31 can be configured to: assign, to each acquired image, a category indicative of whether the acquired image is associated with a properly run drill bit or an improperly run drill bit; and update the database to include each acquired image and the corresponding assigned category. In another aspect, the computing device 31 can be configured to: determine, for any acquired image assigned a category indicative of a properly run drill bit, whether the properly run drill bit experienced accidental damage during the previous drilling cycle; assign, to each acquired image associated with a properly run drill bit that experienced accidental damage, a category indicative of accidental damage to a properly run drill bit; and for each acquired image associated with a properly run drill bit that experienced accidental damage, update the database to include the assigned category indicative of said accidental damage. In further aspects, the computing device 31 can be configured to update the database 206 to include, for each drill bit 16 of a plurality of drill bits, searchable data indicative of the usage, structure, wear, and/or condition of the drill bit, acquired images of the drill bit, and/or an assigned category of the drill bit. Optionally, the searchable data can be indicative of one or more structural conditions of the drill bit. Optionally, the one or more structural conditions can include a lost button or a chipped button.

In exemplary aspects, it is contemplated that if the number of meters drilled since a previous sharpening of a drill bit is negligible, then a failure of the drill bit can be associated with collaring (normally drilling with an inappropriate percussive power or rotation prior to all buttons making contact with the rock) or hitting steel reinforcement in the wall. In these aspects, it is contemplated that the failure code (or other failure information) can be indicative of or categorized as inappropriate usage within the database. In further aspects, it is contemplated that if the number of meters drilled is marginal, e.g., less than 3 meters, then the failure may be due to the drill bit hitting bolts or other ground reinforcements. In these aspects, it is contemplated that the failure code (or other failure information) can be indicative of or categorized as accidental damage. In exemplary applications, it is contemplated that the categorization of such failures can be useful for purposes of contract management.

In exemplary aspects, the computing device 31 can be configured to determine an angular orientation of the drill bit 16 within the imaging device 30 based upon a location of a reference mark on the drill bit during acquisition of the at least one image of the face portion 21 of the drill bit. Thus, it is contemplated that the computing device 31 can track wear or damage progression of individual buttons, with the reference mark providing a fixed reference point to avoid confusion in view of drill bit symmetry. It is further contemplated that the sharpening apparatus movement can be guided based on the location of the reference mark on a given drill bit.

Optionally, in these aspects, the system 1b can further comprise a marking tool 37 configured to apply the reference mark to the drill bit 16 prior to acquisition of the at least one image of the face portion 21 of the drill bit. Optionally, the marking tool can comprise a wire brush, a rotary tool, a stencil, an indentation tool, or combinations thereof.

In some exemplary aspects, the computing device can be configured to compare one or more acquired images of the drill bit to one or more images of a reference drill bit associated with a same product number or part number or model number as the drill bit. As can be understood, the product/part/model number can refer to a general drill bit model, while a serial number can refer to an individual article/item that was manufactured in accordance with that model.

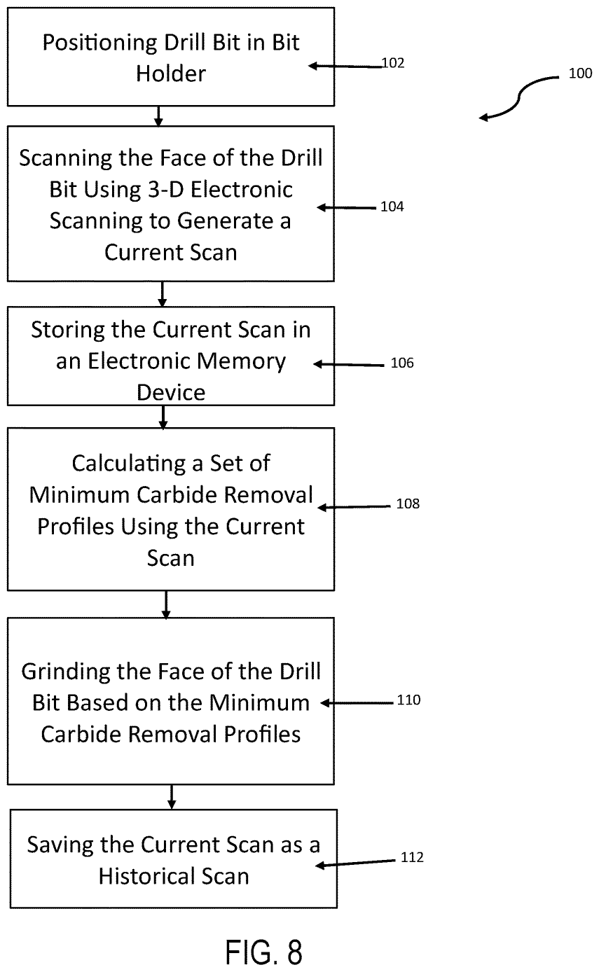

In some exemplary aspects, and with reference to FIGS. 8-10, the system 1b can further comprise a bit holder 102, 202, 302 that is configured to engage an internal surface 17 of the drill bit 16 to support the drill bit in a fixed axial position during imaging, scanning, marking, or other processes disclosed herein.

In some exemplary aspects, the system 1b can further comprise at least one robot (or other suitable automated device) 13 that is in communication with the computing device 31. In these aspects, the robot 13 can have a robotic arm 14 that is coupled to the imaging device 30, and the computing device 31 can be configured to cause the robotic arm to move the imaging device in a pattern that permits acquisition of the at least one image of the drill bit 16. Additionally, or alternatively, a robot 13 can have a robotic arm that is coupled to at least a portion of the drill bit sharpening apparatus 40, and the computing device 31 can be configured to cause the robotic arm to move the drill bit sharpening apparatus in a pattern that permits removal of the determined amount of button material of each button 24 of the plurality of buttons. Thus, in some aspects, the system 1b can comprise first and second robot assemblies, with a first robot assembly being coupled to the imaging device and a second robot assembly being coupled to the drill bit sharpening apparatus. In other aspects, the sharpening apparatus can hold the drill bit in a fixed position and move sharpening elements relative to the drill bit to effect desired sharpening.

Although the robotic arm(s) 14 is/are described as moving the imaging device 30 and/or the sharpening apparatus 40, in other alternative aspects, it is contemplated that the robotic arm(s) can be coupled to the drill bit and configured to move the drill bit in a pattern relative to the imaging device and/or the sharpening apparatus, which can be located in a fixed position, thereby permitting imaging and/or sharpening of the drill bit as disclosed herein.

In further exemplary aspects, the imaging device 30 can be configured to acquire images of each respective drill bit of a batch of drill bits in a sequential order, and the computing device 31 can be configured to associate the images of each respective drill bit with an identifier of the batch and to determine an amount of button material to be removed for each button of each respective drill bit. In these aspects, it is contemplated that the drill bit sharpening apparatus 40 can be configured to sequentially determine, for each respective drill bit of the batch, optimal grinding parameters (e.g., an optimal grinding duration) at each of the buttons of the drill bit. It is further contemplated that the drill bit sharpening apparatus 40 can be configured to determine, based on the sequential order of drill bits of the batch of drill bits, a sequence of sharpening actions needed to remove the determined amount of button material from each button of the plurality of drill bits. Further, it is contemplated that the drill bit sharpening apparatus 40 can be configured to associate the determined sequence of sharpening actions with the identifier of the batch.

In still further exemplary aspects, the computing device 31 can be configured to associate a serial number of the drill bit 16 with drill bit condition information and to update the drill bit condition information. In these aspects, it is contemplated that the drill bit condition information can include one or more of: number of sharpenings; current gauge diameter; damage progression; usage evaluation of previous run of the drill bit; or a usage evaluation of complete life of the drill bit. In some aspects, the drill bit condition information can be stored by a memory of the computing device 31. In other aspects, such drill bit condition information can be provided by a remote computing device 3 as further disclosed herein. Optionally, the computing device 31 can be configured to determine whether the drill bit should be retired, and for any drill bit that should be retired, the computing device can be configured to determine, based on a usage evaluation of a complete life of the drill bit, a classification of the lifetime usage of the drill bit. Optionally, in some aspects, the system 1b can further comprise a reader 54 configured to detect an identifier associated with the drill bit 16. In these aspects, the identifier can be indicative of an identity of the drill bit, and the computing device 31 can be in communication with the reader 54 and configured to receive an input from the reader that corresponds to the identifier associated with the drill bit.

In still further exemplary aspects, the computing device 31 can be configured to associate, with the drill bit condition information, one or more of: drilled distance per run; total drilled distance, average rate of penetration, hours of active drilling, type or characteristics of the rock drilled, location of drilling, time of operation, shift of operation, identification of a drill rig used with the drill bit, or identification of a driller operating the drill bit. In some aspects, such information can be tracked by individual drill bit. In additional aspects, such information can be collated by type of bit, location, rock type, driller, shift, or drill rig.

In further optional aspects, the system 1b can further comprise a drill rig controller 2 in communication with the computing device 31. In these aspects, the drill rig controller 2 can be configured to provide an input to the computing device that is indicative of drilling information, which the computing device (or other computing device in communication with the computing device) can associate with the serial number of the drill bit. Optionally, the drilling information that is associated with the serial number of the drill bit can include one or more of: penetration rate; rig identification; rig operator identification; or a number of meters drilled by the drill bit. Additionally, or alternatively, such information can be provided to the computing device 31 by a remote computing device 3 that is communicatively coupled to the computing device 31. Optionally, the computing device 31 can be configured to update an informational profile assigned to the drill bit to include the drilling information associated with the serial number of the drill bit and the drill bit condition information associated with the drill bit.

As further described below, various operations of the disclosed system 1b can be performed on a network that employs machine learning techniques to determine drill bit usage information, drill bit structural/geometric features, optimal button material removal, and/or characteristics of previous runs of a drill bit. More particularly, in exemplary aspects, the computing device 31 can comprise or be communicatively coupled to a machine learning model as further disclosed herein. It is contemplated that the machine learning model can analyze one or more images of the drill bit and determine a condition or attribute of the drill bit. For example, the machine learning model can use a segmentation model to classify individual pixels or clusters of pixels within the image as corresponding to or not corresponding to one or more physical features associated with the drill bit. A visible output (image, text, graphic, or combination thereof) indicative of the identified physical features (and the corresponding condition of the drill bit) can be displayed (e.g., provided) at a user interface. Optionally, the user interface can allow a user to modify, edit, save, and/or send the output.

### Exemplary Machine Learning Embodiments

As further disclosed herein, systems 1a, 1b can operate on a network, which can facilitate communication between each device/entity of the system. The network may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent/received via the network by any device/entity of the system via a variety of transmission paths, including wireless paths (e.g., satellite paths, Wi-Fi paths, cellular paths, etc.) and terrestrial paths (e.g., wired paths, a direct feed source via a direct line, etc.).

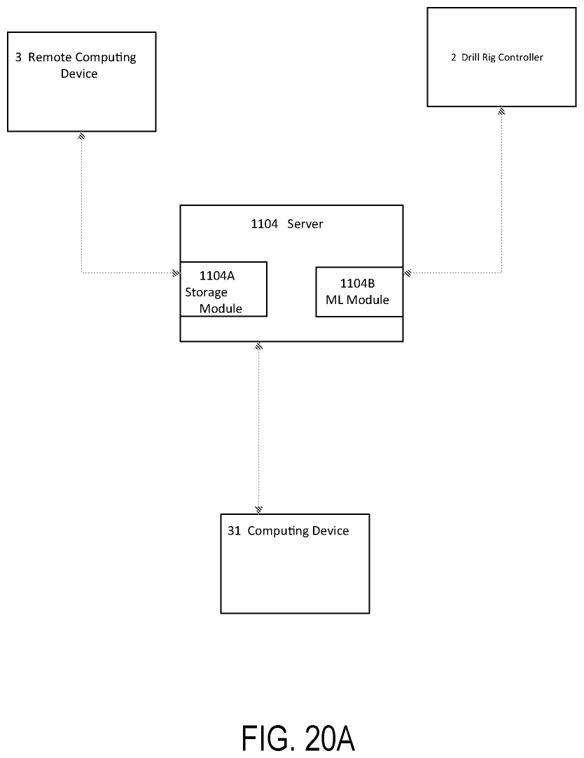

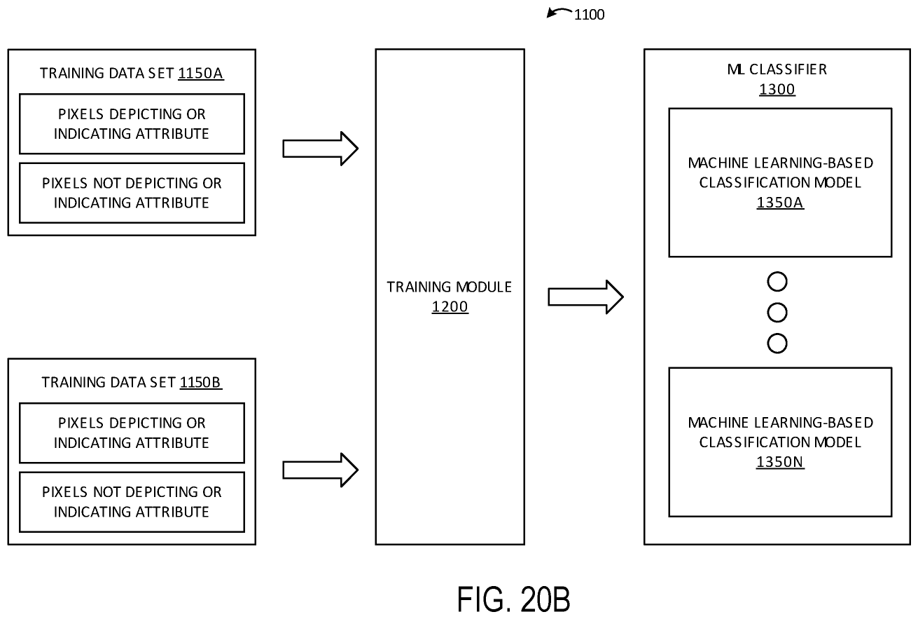

As shown in FIG. 20A, the network can comprise a server 1104, which may be a single computing device or a plurality of computing devices. For purposes of explanation, the description herein will describe the server 1104 and the computing device 31 (and remote computing device 3 and drill rig controller 2) as being separate entities with separate functions. However, it is to be understood that any data sent/received by, as well as any functions performed by, the server 1104 may apply equally to the computing device 31 (or remote computing device 3 or drill rig controller 2)—and vice-versa. For example, the server 1104 may be a module/component of the computing device 31—or vice-versa. Additionally, other computing devices may perform part of the functions described herein with respect to the system 1a, 1b.

As shown in FIG. 20A, the server may include a storage module 1104A and a machine learning module 1104B. The computing device 31 may be in communication with the server 1104 and/or the drill rig controller 2. For purposes of explanation, the description herein will refer to the server 1104—specifically, the machine learning module 1104B—as the device that analyzes the images of the drill bit and related usage/drilling data; however, is to be understood that the computing device 31 (or the drill rig controller 2 or remote computing device 3) may analyze the drill bit images and/or the usage/drilling data in a similar manner.

As described herein, the computing device 31 (or a computing device of imaging device 30) may send (e.g., upload) the drill bit images to the server 1104 via the network. Similarly, it is contemplated that the computing device 31, drill rod controller 2, and/or remote computing device 3 can send historical drill bit images and/or drill bit usage information to the server 1104 via the network. The machine learning module 1104B of the server 1104 may analyze the drill bit images and historical drill bit images and/or drill bit usage information. The drill bit images can be indicative of a current appearance of a face of a given drill bit. The historical drill bit images can include previous images of drill bits that are known to have identified properties or characteristics. Optionally, the historical drill bit images can include previous images of the same drill bit that is currently being analyzed and/or an image of the same model drill bit in a pre-drilling (un-worn) condition. The drill bit usage information can be indicative of the historical usage of the drill bit leading up to the current image(s). For example, drill bit usage information can include: number of drilling operations completed by the drill bit; penetration rate; rig identification; rig operator identification; or a number of meters drilled by the drill bit; previous gauge diameter (measured before the preceding drilling operation); and the like.

The machine learning module 1104B may use, as an example, a segmentation model to compare the drill bit images with the historical drill bit images. For example, the machine learning model may use a segmentation model to classify each pixel of a plurality of pixels of the drill bit images as corresponding to or not corresponding to a particular pixel of the historical drill bit image. As another example, the machine learning module 1104B can use the segmentation model to classify each pixel of a plurality of pixels of a historical bit image as corresponding to or not corresponding to a particular pixel(s) of the current drill bit image. Thus, the segmentation model may align the current drill bit images with historical drill bit images—or vice-versa.

Additionally, or alternatively, the machine learning model may be trained, as further discussed herein, by applying one or more machine learning models and/or algorithms to a plurality of training bit images and bit usage data associated with a plurality of training drill bits. The term “segmentation” refers to analysis of an image(s) of the drill bit and/or historical drill bit image(s) to determine related areas of the image(s). In some cases, segmentation may be based on semantic content of the image(s). For example, segmentation analysis performed on the image(s) may indicate a region of the image(s) depicting a particular attribute(s) of the corresponding drill bit. In some cases, segmentation analysis may produce segmentation data. The segmentation data may indicate one or more segmented regions of the analyzed image(s). For example, the segmentation data may include a set of labels, such as pairwise labels (e.g., labels having a value indicating “yes” or “no”) indicating whether a given pixel in the image(s) is part of a region depicting a particular attribute(s) of the corresponding drill bit. In some cases, labels may have multiple available values, such as a set of labels indicating whether a given pixel depicts a first attribute, a second attribute, a combination of attributes, and so on. The segmentation data may include numerical data, such as data indicating a probability that a given pixel is a region depicting a particular attribute(s) of the corresponding drill bit. In some cases, the segmentation data may include additional types of data, such as text, database records, or additional data types, or structures.

In some examples, structural and/or condition data associated with the drill bit may be determined. The structural and/or condition data may comprise—or be indicative of—one or more physical features (e.g., defects) associated with the drill bit. The one or more physical features may comprise broken buttons; change in gauge diameter; lost or missing buttons; over-drilled buttons; portions of the bit body (that supports the buttons) contacting rock (or other formation material); insufficient rotation speed; or excessive rotation speed. For example, the segmentation model may determine the condition data. As shown in FIG. 20A, the storage module 1104A may provide/send a first drill bit image to the machine learning module 1104B. The machine learning module 1104B may use the segmentation model to align the first drill bit image with a historical drill bit image for the same drill bit (or same type of drill bit). Module 1104B may generate an output image may overlay the images of the two drill bit images to depict the changes relative to the historical image.

The machine learning module 1104B may send the output image to the storage module 1104A. The storage module 1104A may send the output image to the computing device 31. The computing device 31 may receive the output image via an application, which may be displayed via a user interface of the application at the computing device 31. A user of the application may interact with the output image and provide one or more user edits, such as by adjusting an attribute/feature, modifying an attribute/feature, drawing a position for a new attribute/feature, etc. The application may provide an indication of the one or more user edits to the server 104 (e.g., an edited version of the output image). The indication of the one or more user edits may be stored at the storage module 1104A.

Optionally, the user interface may display an output image containing an image of a drill bit and one or more attributes associated with the drill bit, such as a broken button, a missing button, an over-drilled button, and the like. The one or more attributes may be provided in the output image via the segmentation mask.

As described herein, the user interface may include a plurality of editing tools that facilitate the user interacting with the output image and/or the segmentation mask for a drill bit. The user may interact with the output image and/or the segmentation mask and provide one or more user edits, such as by adjusting an attribute (e.g., an indication of a physical feature), modifying an attribute, drawing a position for a new attribute, etc. For example, one such tool may allow the user to create a user-defined attribute associated with the drill bit by drawing a line or circle over a portion of the output image. The user interface may include a list of attribute categories that allow the user to categorize the user-defined attribute. For example, the user-defined attribute may be a broken button (or an indication that a button is not broken, even if it may have been previously identified as a broken button by the segmentation mask). However, any category of user-defined attribute may be added. The user may also modify and/or delete any attribute indicated by the segmentation mask.

The application may provide an indication of one or more user edits made to any of the attributes indicated by the segmentation mask (or any created or deleted attributes) to the server 1104. For example, the application may send the indication of the one or more user edits (e.g., an edited version of the output image) to the server 1104. Expert annotation may be provided to the server 1104 by a third-party computing device (not shown). The expert annotation may be associated with the one or more user edits. For example, the expert annotation may comprise an indication of an acceptance of the one or more user edits, a rejection of the one or more user edits, or an adjustment to the one or more user edits. The one or more user edits and/or the expert annotation may be used by the machine learning module 1104B to optimize the segmentation model and/or the structural data model. For example, the one or more user edits and/or the expert annotation may be used by the machine learning module 1104B to retrain the segmentation model and/or the structural data model.

Turning now to FIG. 20B, a system 1100 is shown. The system 1100 may be configured to use machine learning techniques to train, based on an analysis of one or more training data sets 1150A-1150B by a training module 1200, at least one machine learning-based classifier 1300 that is configured to classify pixels in a drill bit image as depicting or not depicting a particular attribute(s) of a corresponding drill bit. The at least one machine learning-based classifier 1300 may comprise the machine learning module 1104B (e.g., a segmentation model and/or an structural data model).

The system 1100 may determine (e.g., access, receive, retrieve, etc.) the training data set 1150A. The training data set 1150A may comprise first drill bit images (e.g., a portion of a plurality of drill bit images) associated with a plurality of drill bits. The system 1100 may determine (e.g., access, receive, retrieve, etc.) the training data set 1150B. The training data set 1150B may comprise second drill bit images (e.g., a portion of the plurality of drill bit images) associated with the plurality of drill bits. The first drill bits and the second drill bits may each contain one or more imaging result datasets associated with drill bit images, and each imaging result dataset may be associated with one or more pixel attributes. The one or more pixel attributes may include a level of color saturation, a hue, a contrast level, a relative position, a combination thereof, and/or the like. Each imaging result dataset may include a labeled list of imaging results. The labels may comprise “attribute pixel” (corresponding to a pixel that depicts or indicates a particular attribute) and “non-attribute pixel” (corresponding to a pixel that does not depict or indicate a particular attribute).

Drill bit images may be randomly assigned to the training data set 1150B or to a testing data set. In some implementations, the assignment of data to a training data set or a testing data set may not be completely random. In this case, one or more criteria may be used during the assignment, such as ensuring that similar numbers of drill bit images are in each of the training and testing data sets. In general, any suitable method may be used to assign the data to the training or testing data sets, while ensuring that the distributions of sufficient quality and insufficient quality labels are somewhat similar in the training data set and the testing data set.

The training module 1200 may train the machine learning-based classifier 1300 by extracting a feature set from the training data set 1150A according to one or more feature selection techniques. The training module 1200 may further define the feature set obtained from the training data set 1150A by applying one or more feature selection techniques to the training data set 1150B that includes statistically significant features of positive examples (e.g., pixels depicting a particular attribute(s) of a corresponding drill bit) and statistically significant features of negative examples (e.g., pixels not depicting a particular attribute(s) of a corresponding drill bit). The feature set extracted from the training data set 1150A and/or the training dataset 1150B may comprise segmentation data and/or structural data as described herein. For example, the feature set may comprise features associated with pixels that are indicative of the one or more physical features described herein. The feature set may be derived from the segmentation data indicated by the plurality of drill bit images and/or the structural data disclosed herein.

The training module 1200 may extract the feature set from the training data set 1150A and/or the training data set 1150B in a variety of ways. The training module 1200 may perform feature extraction multiple times, each time using a different feature-extraction technique. In an embodiment, the feature sets generated using the different techniques may each be used to generate different machine learning-based classification models 1350. For example, the feature set with the highest quality metrics may be selected for use in training. The training module 1200 may use the feature set(s) to build one or more machine learning-based classification models 1350A-1350N that are configured to indicate whether or not new drill bit images contain or do not contain pixels depicting a particular attribute(s) of the corresponding drill bits.

The training data set 1150A and/or the training data set 1150B may be analyzed to determine any dependencies, associations, and/or correlations between extracted features and the sufficient quality/insufficient quality labels in the training data set 1150A and/or the training data set 1150B. The identified correlations may have the form of a list of features that are associated with labels for pixels depicting a particular attribute(s) of a corresponding drill bit and labels for pixels not depicting the particular attribute(s) of the corresponding drill bit. The features may be considered as variables in the machine learning context. The term “feature,” as used herein, may refer to any characteristic of an item of data that may be used to determine whether the item of data falls within one or more specific categories. By way of example, the features described herein may comprise the one or more pixel attributes. The one or more pixel attributes may include a dimension, a geometric relationship, a level of color saturation, a hue, a contrast level, a relative position, a combination thereof, and/or the like.

A feature selection technique may comprise one or more feature selection rules. The one or more feature selection rules may comprise a pixel attribute and a pixel attribute occurrence rule. The pixel attribute occurrence rule may comprise determining which pixel attributes in the training data set 1150A occur over a threshold number of times and identifying those pixel attributes that satisfy the threshold as candidate features. For example, any pixel attributes that appear greater than or equal to 8 times in the training data set 1150A may be considered as candidate features. Any pixel attributes appearing less than 8 times may be excluded from consideration as a feature. Any threshold amount may be used as needed.

A single feature selection rule may be applied to select features or multiple feature selection rules may be applied to select features. The feature selection rules may be applied in a cascading fashion, with the feature selection rules being applied in a specific order and applied to the results of the previous rule. For example, the pixel attribute occurrence rule may be applied to the training data set 1150A to generate a first list of pixel attributes. A final list of candidate features may be analyzed according to additional feature selection techniques to determine one or more candidate groups (e.g., groups of pixel attributes). Any suitable computational technique may be used to identify the candidate feature groups using any feature selection technique such as filter, wrapper, and/or embedded methods. One or more candidate feature groups may be selected according to a filter method. Filter methods include, for example, Pearson's correlation, linear discriminant analysis, analysis of variance (ANOVA), chi-square, combinations thereof, and the like. The selection of features according to filter methods are independent of any machine learning algorithms. Instead, features may be selected on the basis of scores in various statistical tests for their correlation with the outcome variable (e.g., pixels that depict or do not depict a particular attribute(s) of a corresponding drill bit).

As another example, one or more candidate feature groups may be selected according to a wrapper method. A wrapper method may be configured to use a subset of features and train a machine learning model using the subset of features. Based on the inferences that drawn from a previous model, features may be added and/or deleted from the subset. Wrapper methods include, for example, forward feature selection, backward feature elimination, recursive feature elimination, combinations thereof, and the like. In an embodiment, forward feature selection may be used to identify one or more candidate feature groups. Forward feature selection is an iterative method that begins with no features in the machine learning model. In each iteration, the feature which best improves the model is added until an addition of a new feature does not improve the performance of the machine learning model. In an embodiment, backward elimination may be used to identify one or more candidate feature groups. Backward elimination is an iterative method that begins with all features in the machine learning model. In each iteration, the least significant feature is removed until no improvement is observed on removal of features. Recursive feature elimination may be used to identify one or more candidate feature groups. Recursive feature elimination is a greedy optimization algorithm which aims to find the best performing feature subset. Recursive feature elimination repeatedly creates models and keeps aside the best or the worst performing feature at each iteration. Recursive feature elimination constructs the next model with the features remaining until all the features are exhausted. Recursive feature elimination then ranks the features based on the order of their elimination.

As a further example, one or more candidate feature groups may be selected according to an embedded method. Embedded methods combine the qualities of filter and wrapper methods. Embedded methods include, for example, Least Absolute Shrinkage and Selection Operator (LASSO) and ridge regression which implement penalization functions to reduce overfitting. For example, LASSO regression performs L1 regularization which adds a penalty equivalent to absolute value of the magnitude of coefficients and ridge regression performs L2 regularization which adds a penalty equivalent to square of the magnitude of coefficients.

After the training module 1200 has generated a feature set(s), the training module 1200 may generate a machine learning-based classification model 1350 based on the feature set(s). A machine learning-based classification model may refer to a complex mathematical model for data classification that is generated using machine-learning techniques. In one example, this machine learning-based classifier may include a map of support vectors that represent boundary features. By way of example, boundary features may be selected from, and/or represent the highest-ranked features in, a feature set.

The training module 1200 may use the feature sets extracted from the training data set 1150A and/or the training data set 1150B to build a machine learning-based classification model 1350A-1350N for each classification category (e.g., each attribute of a corresponding drill bit). In some examples, the machine learning-based classification models 1350A-1350N may be combined into a single machine learning-based classification model 1350. Similarly, the machine learning-based classifier 1300 may represent a single classifier containing a single or a plurality of machine learning-based classification models 1350 and/or multiple classifiers containing a single or a plurality of machine learning-based classification models 1350.

The extracted features (e.g., one or more pixel attributes) may be combined in a classification model trained using a machine learning approach such as discriminant analysis; decision tree; a nearest neighbor (NN) algorithm (e.g., k-NN models, replicator NN models, etc.); statistical algorithm (e.g., Bayesian networks, etc.); clustering algorithm (e.g., k-means, mean-shift, etc.); neural networks (e.g., reservoir networks, artificial neural networks, etc.); support vector machines (SVMs); logistic regression algorithms; linear regression algorithms; Markov models or chains; principal component analysis (PCA) (e.g., for linear models); multi-layer perceptron (MLP) ANNs (e.g., for non-linear models); replicating reservoir networks (e.g., for non-linear models, typically for time series); random forest classification; a combination thereof and/or the like. The resulting machine learning-based classifier 1300 may comprise a decision rule or a mapping for each candidate pixel attribute to assign a pixel(s) to a class (e.g., depicting or not depicting a particular attribute(s) of a corresponding drill bit).

The candidate pixel attributes and the machine learning-based classifier 1300 may be used to predict a label (e.g., depicting or not depicting a particular attribute(s) of a corresponding drill bit) for imaging results in the testing data set (e.g., in a portion of second drill bit images/acoustic images). In one example, the prediction for each imaging result in the testing data set includes a confidence level that corresponds to a likelihood or a probability that the corresponding pixel(s) depicts or does not depict a particular attribute(s) of a corresponding drill bit. The confidence level may be a value between zero and one, and it may represent a likelihood that the corresponding pixel(s) belongs to a particular class. In one example, when there are two statuses (e.g., depicting or not depicting a particular attribute(s) of a corresponding drill bit), the confidence level may correspond to a value p, which refers to a likelihood that a particular pixel belongs to the first status (e.g., depicting the particular attribute(s)). In this case, the value 1−p may refer to a likelihood that the particular pixel belongs to the second status (e.g., not depicting the particular attribute(s)). In general, multiple confidence levels may be provided for each pixel and for each candidate pixel attribute when there are more than two statuses. A top performing candidate pixel attribute may be determined by comparing the result obtained for each pixel with the known sufficient quality/insufficient quality status for each corresponding drill bit image in the testing data set (e.g., by comparing the result obtained for each pixel with the labeled drill bit images of the second portion of the second drill bit images). In general, the top performing candidate pixel attribute for a particular attribute(s) of the corresponding drill bit image will have results that closely match the known depicting/not depicting statuses.

The top performing pixel attribute may be used to predict the depicting/not depicting of pixels of a new drill bit image. For example, a new drill bit image may be determined/received. The new drill bit image may be provided to the machine learning-based classifier 1300 which may, based on the top performing pixel attribute for the particular attribute(s) of the corresponding drill bit, classify the pixels of the new drill bit image as depicting or not depicting the particular attribute(s).

As noted above, the application may provide an indication of one or more user edits made to any of the attributes indicated by the segmentation mask/overlay (or any created or deleted attributes) to the server 1104. For example, the user may edit any of the attributes indicated by the segmentation mask/overlay by dragging some of its points to desired positions via mouse movements in order to optimally delineate depictions of boundaries of the attribute(s). As another example, the user may draw or redraw parts of the segmentation mask/overlay via a mouse. Other input devices or methods of obtaining user commands may also be used. The one or more user edits may be used by the machine learning module 1104B to optimize the segmentation model and/or the structural data model. For example, the training module 1200 may extract one or more features from output images containing one or more user edits as discussed above. The training module 1200 may use the one or more features to retrain the machine learning-based classifier 1300 and thereby continually improve results provided by the machine learning-based classifier 1300.

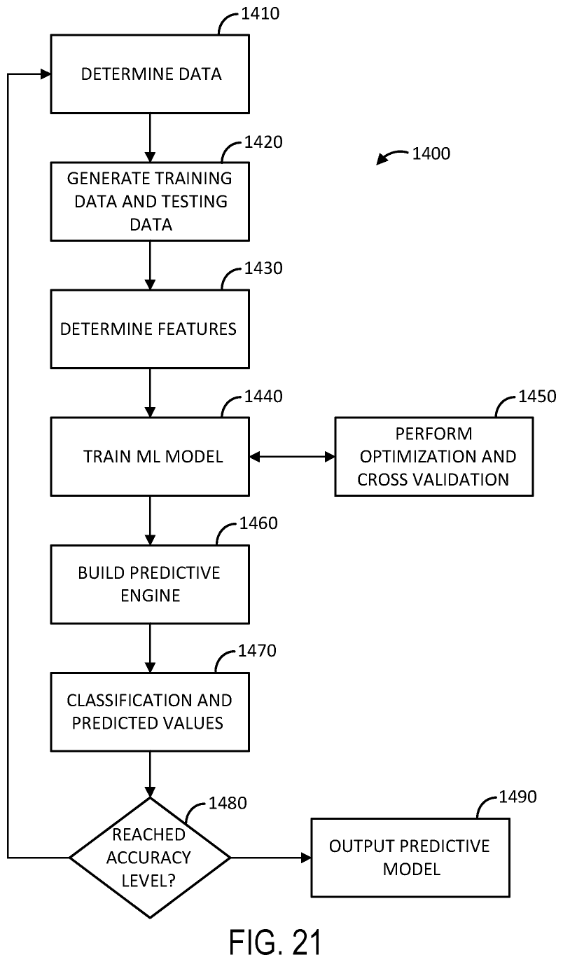

Turning now to FIG. 21, a flowchart illustrating an example training method 1400 is shown. The method 1400 may be used for generating the machine learning-based classifier 1300 using the training module 1200. The training module 1200 can implement supervised, unsupervised, and/or semi-supervised (e.g., reinforcement based) machine learning-based classification models 1350. The method 1400 illustrated in FIG. 21 is an example of a supervised learning method; variations of this example of training method are discussed below, however, other training methods can be analogously implemented to train unsupervised and/or semi-supervised machine learning models.

The training method 1400 may determine (e.g., access, receive, retrieve, etc.) first drill bit images associated with a plurality of drill bits (e.g., first drill bits) and second drill bit images associated with the plurality of drill bits (e.g., second drill bits) at step 1410. The first drill bits and the second drill bits may each contain one or more imaging result datasets associated with drill bit images, and each imaging result dataset may be associated with one or more pixel attributes. The one or more pixel attributes may include a level of color saturation, a dimension, a geometric relationship, a hue, a contrast level, a relative position, a combination thereof, and/or the like. Each imaging result dataset may include a labeled list of imaging results. The labels may comprise “attribute pixel” and “non-attribute pixel.”

The training method 1400 may generate, at step 1420, a training data set and a testing data set. The training data set and the testing data set may be generated by randomly assigning labeled imaging results from the drill bit images to either the training data set or the testing data set. In some implementations, the assignment of labeled imaging results as training or test samples may not be completely random. In an embodiment, only the labeled imaging results for a specific drill bit type and/or class (e.g., drill bits having a particular dimension or having particular performance characteristics) may be used to generate the training data set and the testing data set. In an embodiment, a majority of the labeled imaging results for the specific drill bit type and/or class may be used to generate the training data set. For example, 75% of the labeled imaging results for the specific drill bit type and/or class may be used to generate the training data set and 25% may be used to generate the testing data set.

The training method 1400 may determine (e.g., extract, select, etc.), at step 1430, one or more features that can be used by, for example, a classifier to differentiate among different classifications (e.g., “attribute pixel” vs. “non-attribute pixel.”). The one or more features may comprise a set of one or more pixel attributes. The one or more pixel attributes may include a dimension, a geometric relationship, a level of color saturation, a hue, a contrast level, a relative position, a combination thereof, and/or the like. In an embodiment, the training method 1400 may determine a set of features from the first drill bit images. In another embodiment, the training method 1400 may determine a set of features from the second drill bit images. In a further embodiment, a set of features may be determined from labeled imaging results from a drill bit type and/or class different than the drill bit type and/or class associated with the labeled imaging results of the training data set and the testing data set. In other words, labeled imaging results from the different drill bit type and/or class may be used for feature determination, rather than for training a machine learning model. The training data set may be used in conjunction with the labeled imaging results from the different drill bit type and/or class to determine the one or more features. The labeled imaging results from the different drill bit type and/or class may be used to determine an initial set of features, which may be further reduced using the training data set.

The training method 1400 may train one or more machine learning models using the one or more features at step 1440. In one embodiment, the machine learning models may be trained using supervised learning. In another embodiment, other machine learning techniques may be employed, including unsupervised learning and semi-supervised. The machine learning models trained at 1440 may be selected based on different criteria depending on the problem to be solved and/or data available in the training data set. For example, machine learning classifiers can suffer from different degrees of bias. Accordingly, more than one machine learning model can be trained at 1440, and then optimized, improved, and cross-validated at step 1450.

The training method 1400 may select one or more machine learning models to build a predictive model at 1460 (e.g., the at least one machine learning-based classifier 1300). The predictive model may be evaluated using the testing data set. The predictive model may analyze the testing data set and generate classification values and/or predicted values at step 1470. Classification and/or prediction values may be evaluated at step 1480 to determine whether such values have achieved a desired accuracy level.

Performance of the predictive model described herein may be evaluated in a number of ways based on a number of true positives, false positives, true negatives, and/or false negatives classifications of pixels in images of drill bits. For example, the false positives of the predictive model may refer to a number of times the predictive model incorrectly classified a pixel(s) as depicting a particular attribute that in reality did not depict the particular attribute. Conversely, the false negatives of the machine learning model(s) may refer to a number of times the predictive model classified one or more pixels of an image of a drill bit as not depicting a particular attribute when, in fact, the one or more pixels did depict the particular attribute. True negatives and true positives may refer to a number of times the predictive model correctly classified one or more pixels of an image of a drill bit as having sufficient depicting of a particular attribute or not depicting the particular attribute. Related to these measurements are the concepts of recall and precision. Generally, recall refers to a ratio of true positives to a sum of true positives and false negatives, which quantifies a sensitivity of the predictive model. Similarly, precision refers to a ratio of true positives to a sum of true positives and false positives. Further, the predictive model may be evaluated based on a level of mean error and a level of mean percentage error. Once a desired accuracy level of the predictive model is reached, the training phase ends and the predictive model may be output at step 1490. However, when the desired accuracy level is not reached a subsequent iteration of the method 1400 may be performed starting at step 1410 with variations such as, for example, considering a larger collection of images of drill bits.

### Exemplary Computer-Implemented Systems

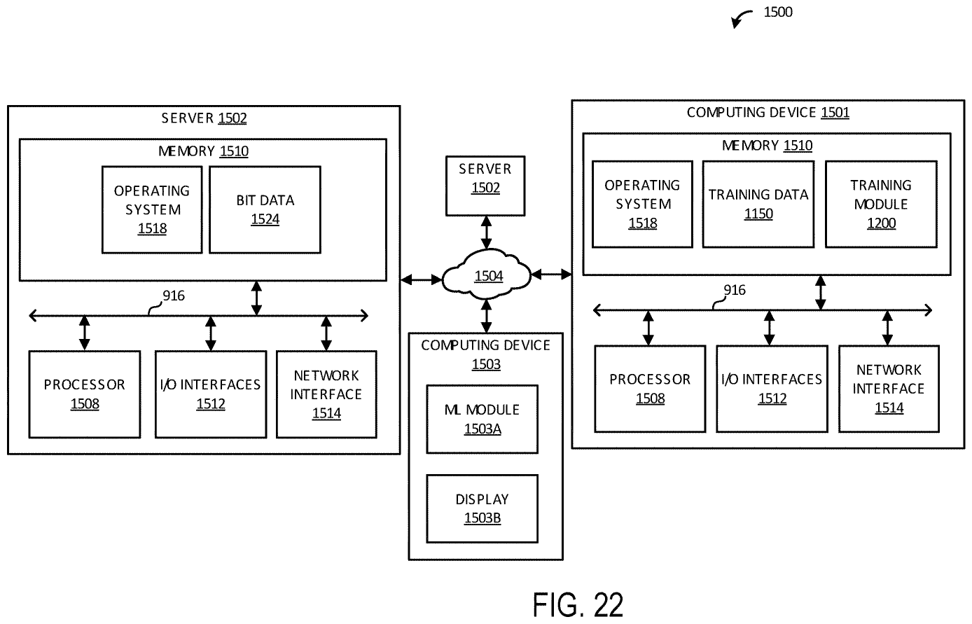

As discussed herein, the present methods and systems may be computer-implemented. FIG. 22 shows a block diagram depicting an environment 1500 comprising non-limiting examples of a computing device 1501 and a server 1502 connected through a network 1504. As an example, the server 1104 and/or the computing device 31 of the system 1a, 1b may be a computing device 1501 and/or a server 1502 as described herein with respect to FIG. 22. In an aspect, some or all steps of any described method may be performed on a computing device as described herein. The computing device 1501 can comprise one or multiple computers configured to store one or more of the training module 1200, training data 1150 (e.g., labeled images/pixels), and the like. The server 1502 can comprise one or multiple computers configured to store drill bit data 1524 (e.g., a plurality of images of drill bits and corresponding structural data). Multiple servers 1502 can communicate with the computing device 1501 via the network 1504.

The computing device 1501 and the server 1502 can be a digital computer that, in terms of hardware architecture, generally includes a processor 1508, memory system 1510, input/output (I/O) interfaces 1512, and network interfaces 1514. These components (1508, 1510, 1512, and 1514) are communicatively coupled via a local interface 1516. The local interface 1516 can be, for example, but not limited to, one or more buses or other wired or wireless connections, as is known in the art. The local interface 1516 can have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 1508 can be a hardware device for executing software, particularly that stored in memory system 1510. The processor 1508 can be any custom made or commercially available processor, a central processing unit (CPU), an auxiliary processor among several processors associated with the computing device 1501 and the server 1502, a semiconductor-based microprocessor (in the form of a microchip or chip set), or generally any device for executing software instructions. When the computing device 1501 and/or the server 1502 is in operation, the processor 1508 can be configured to execute software stored within the memory system 1510, to communicate data to and from the memory system 1510, and to generally control operations of the computing device 1501 and the server 1502 pursuant to the software.

The I/O interfaces 1512 can be used to receive user input from, and/or for providing system output to, one or more devices or components. User input can be provided via, for example, a keyboard and/or a mouse. System output can be provided via a display device and a printer (not shown). I/O interfaces 1512 can include, for example, a serial port, a parallel port, a Small Computer System Interface (SCSI), an infrared (IR) interface, a radio frequency (RF) interface, and/or a universal serial bus (USB) interface.

The network interface 1514 can be used to transmit and receive from the computing device 1501 and/or the server 1502 on the network 1504. The network interface 1514 may include, for example, a 11BaseT Ethernet Adaptor, a 110BaseT Ethernet Adaptor, a LAN PHY Ethernet Adaptor, a Token Ring Adaptor, a wireless network adapter (e.g., WiFi, cellular, satellite), or any other suitable network interface device. The network interface 1514 may include address, control, and/or data connections to enable appropriate communications on the network 1504.

The memory system 1510 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 1510 may incorporate electronic, magnetic, optical, and/or other types of storage media. Note that the memory system 1510 can have a distributed architecture, where various components are situated remote from one another, but can be accessed by the processor 1508.

The software in memory system 1510 may include one or more software programs, each of which comprises an ordered listing of executable instructions for implementing logical functions. In the example of FIG. 22, the software in the memory system 1510 of the computing device 1501 can comprise the training module 1200 (or subcomponents thereof), the training dataset 1150A, the training dataset 1150B, and a suitable operating system (O/S) 1518. In the example of FIG. 22, the software in the memory system 1510 of the server 1502 can comprise, the drill bit data 1524, and a suitable operating system (O/S) 1518. The operating system 1518 essentially controls the execution of other computer programs and provides scheduling, input-output control, file and data management, memory management, and communication control and related services.

The environment 1500 may further comprise a computing device 1503. The computing device 1503 may be a computing device and/or system, such as the server 1104 and/or the computing device 31 of the system 1a, 1b. The computing device 1503 may use a predictive model stored in a Machine Learning (ML) module 1503A to classify one or more pixels of images of drill bits as depicting or not depicting a particular attribute(s). The computing device 1503 may include a display 1503B for presentation of a user interface.

For purposes of illustration, application programs and other executable program components such as the operating system 1518 are illustrated herein as discrete blocks, although it is recognized that such programs and components can reside at various times in different storage components of the computing device 1501 and/or the server 1502. An implementation of the training module 1200 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

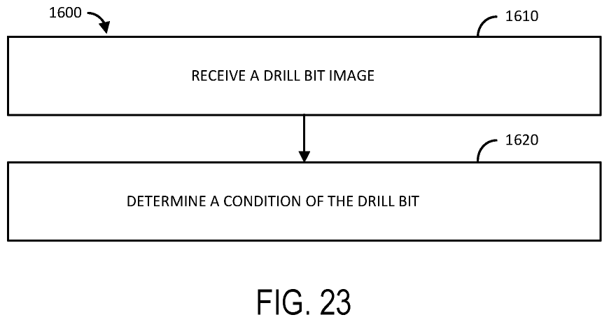

Turning now to FIG. 23, a flowchart of an example method 1600 for determining a condition of a drill bit is shown. The method 1600 may be performed in whole or in part by a single computing device, a plurality of computing devices, and the like. For example, the server 1104 and/or the computing device 31 of the system 1a, 1b, the training module 1200 of the system 1a, 1b, and/or the computing device 1503 may be configured to perform the method 1600.

At step 1610, a computing device may receive a drill bit image (and, optionally, structural or usage data associated with the drill bit). The drill bit image may comprise one of the plurality of drill bit images, and the structural or usage data (when provided) may comprise information concerning the past usage of the drill bit (number of meters drilled, drilling conditions, previous gauge measurements, and the like). The drill bit image may be analyzed by a machine learning model, such as the machine learning module 1104A or the at least one machine learning-based classifier 1300. The machine learning model may comprise a segmentation model.

At step 1620, the machine learning model may determine a condition of the drill bit. For example, the segmentation model may align the drill bit image with a historical drill bit image by classifying each pixel of a plurality of pixels of the drill bit image as corresponding to or not corresponding to a particular pixel(s) of the historical drill bit image. As another example, the machine learning model may use the segmentation model to classify each pixel of a plurality of pixels of a historical drill bit image as corresponding to or not corresponding to a particular pixel of the current drill bit image(s). Thus, the segmentation model may align the drill bit image with the historical drill bit image—or vice-versa.

In exemplary aspects, the machine learning module can determine a condition (e.g., usage, wear, structural, etc.) of the drill bit based on the segmentation model and/or other comparison between the images of drill bit and historical drill bit images (such as, for example, a representative image of the same drill bit model in a pre-drilling condition). In exemplary aspects, the machine learning module can determine an estimated remaining life of the drill bit.

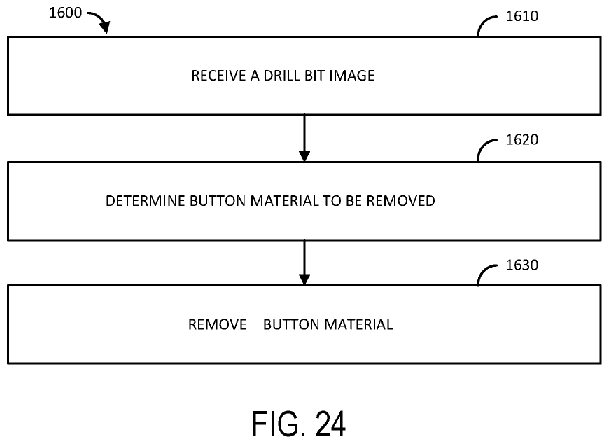

Turning now to FIG. 24, a flowchart of an example method 1700 for determining an amount of button material to be removed from a drill bit is shown. The method 1700 may be performed in whole or in part by a single computing device, a plurality of computing devices, and the like. For example, the server 1104 and/or the computing device 31 of the system 1a, 1b, the training module 1200 of the system 1a, 1b, and/or the computing device 1503 may be configured to perform the method 1700.

At step 1710, a computing device may receive a drill bit image (and, optionally, structural or usage data associated with the drill bit). The drill bit image may comprise one of the plurality of drill bit images, and the structural or usage data (when provided) may comprise information concerning the past usage of the drill bit (number of meters drilled, drilling conditions, previous gauge measurements, and the like). Optionally, the drill bit image may be analyzed by a machine learning model, such as the machine learning module 1104A or the at least one machine learning-based classifier 1300. The machine learning model may comprise a segmentation model.

At step 1720, the computing device may determine a quantity of button material to be removed. Optionally, the machine learning module can compare the drill bit image to historical drill bit images and/or previously classified bit removal profiles for historical drill bit images to determine a quantity of button material to be removed. Alternatively, it is contemplated that the quantity of button material to be removed can be determined without employing machine learning and instead relying on the computing device to determine the gauge measurements and/or wear flat measurements at the buttons (e.g., based on acquired images) and to use those measurements to determine the quantity of button material to be removed at each button as further disclosed herein.

At step 1730, at each button, the drill bit sharpening apparatus 40 removes button material in accordance with the determined quantity of button material to be removed for that button.

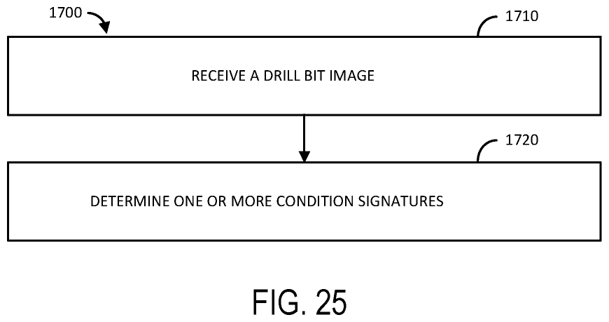

Turning now to FIG. 25, a flowchart of an example method 1800 for determining a condition of a drill bit is shown. The method 1800 may be performed in whole or in part by a single computing device, a plurality of computing devices, and the like. For example, the server 1104 and/or the computing device 31 of the system 1a, 1b, the training module 1200 of the system 1a, 1b, and/or the computing device 1503 may be configured to perform the method 1800.

At step 1810, a computing device may receive a drill bit image (and, optionally, structural or usage data associated with the drill bit). The drill bit image may comprise one of the plurality of drill bit images, and the structural or usage data (when provided) may comprise information concerning the past usage of the drill bit (number of meters drilled, drilling conditions, previous gauge measurements, and the like). Optionally, the drill bit image may be analyzed by a machine learning model, such as the machine learning module 1104A or the at least one machine learning-based classifier 1300. The machine learning model may comprise a segmentation model.

At step 1820, the machine learning model may determine one or more condition signatures of the drill bit. For example, the segmentation model may align the drill bit image with a historical drill bit image by classifying each pixel of a plurality of pixels of the drill bit image as corresponding to or not corresponding to a particular pixel(s) of the historical drill bit image. As another example, the machine learning model may use the segmentation model to classify each pixel of a plurality of pixels of a historical drill bit image as corresponding to or not corresponding to a particular pixel of the current drill bit image(s). Thus, the segmentation model may align the drill bit image with the historical drill bit image—or vice-versa.

In exemplary aspects, the machine learning module can determine a condition signature of the drill bit based on the segmentation model and/or other comparison between the images of drill bit and historical drill bit images (such as, for example, a representative image of the same drill bit model in a known condition). In exemplary aspects, the machine learning module can identify or determine condition signatures (attributes) that are associated with one or more of the following conditions: broken buttons; change in gauge diameter; lost or missing buttons; over-drilled buttons; portions of the bit body (that supports the buttons) contacting rock (or other formation material); insufficient rotation speed; or excessive rotation speed.

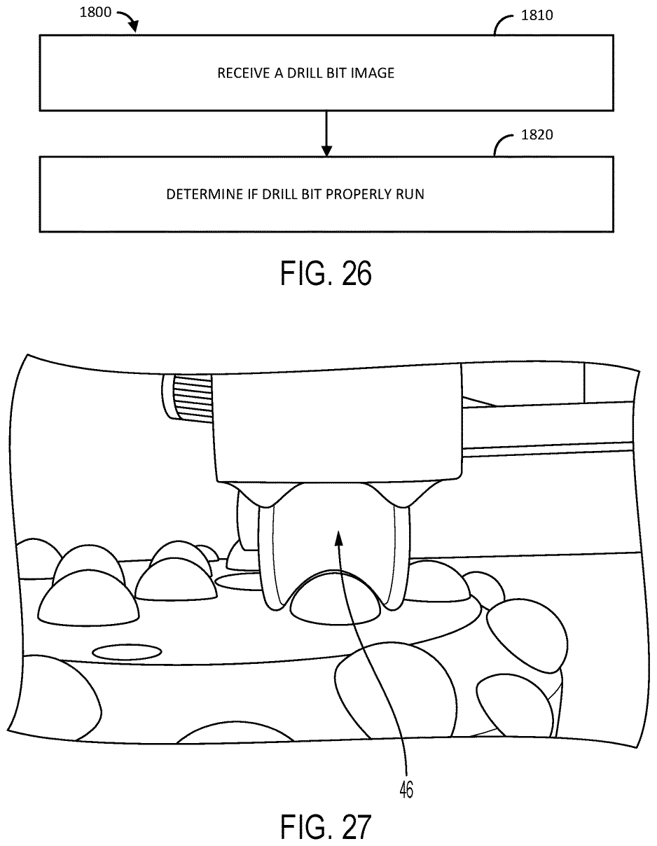

Turning now to FIG. 26, a flowchart of an example method 1900 for determining a condition of a drill bit is shown. The method 1900 may be performed in whole or in part by a single computing device, a plurality of computing devices, and the like. For example, the server 1104 and/or the computing device 31 of the system 1a, 1b, the training module 1200 of the system 1a, 1b, and/or the computing device 1503 may be configured to perform the method 1900.

At step 1910, a computing device may receive a drill bit image (and, optionally, structural or usage data associated with the drill bit). The drill bit image may comprise one of the plurality of drill bit images, and the structural or usage data (when provided) may comprise information concerning the past usage of the drill bit (number of meters drilled, drilling conditions, previous gauge measurements, and the like). Optionally, the drill bit image may be analyzed by a machine learning model, such as the machine learning module 1104A or the at least one machine learning-based classifier 1300. The machine learning model may comprise a segmentation model.

At step 1920, the machine learning model may determine whether the drill bit was properly or improperly run. For example, the segmentation model may align the drill bit image with a historical drill bit image by classifying each pixel of a plurality of pixels of the drill bit image as corresponding to or not corresponding to a particular pixel(s) of the historical drill bit image. As another example, the machine learning model may use the segmentation model to classify each pixel of a plurality of pixels of a historical drill bit image as corresponding to or not corresponding to a particular pixel of the current drill bit image(s). Thus, the segmentation model may align the drill bit image with the historical drill bit image—or vice-versa.

In exemplary aspects, the machine learning model can classify the drill bit as being properly run or improperly run based on a comparison between the drill bit image and analysis of historical drill bit images that have been classified as properly run or improperly run.

### Exemplary Embodiments

The following description provides non-limiting examples of system configurations that include one or more of the features and/or components set forth in the preceding description and the claims which follow the specification.

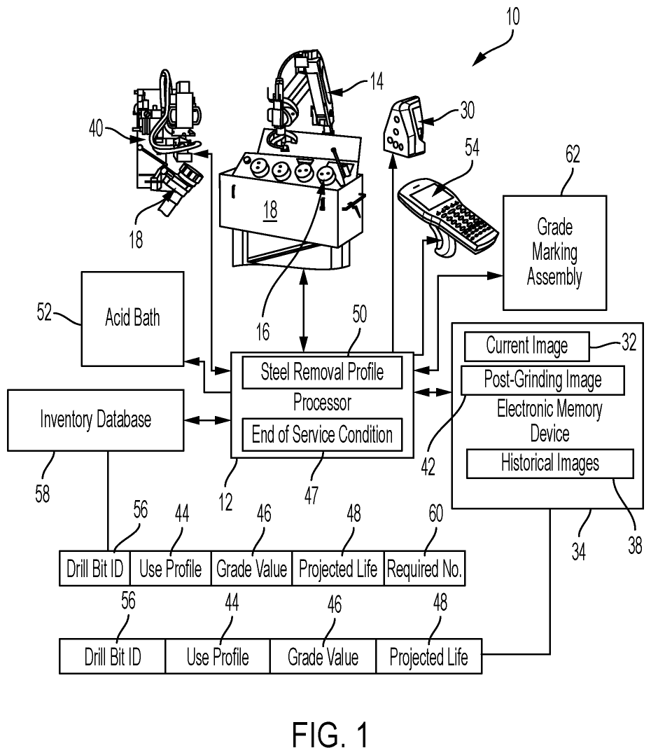

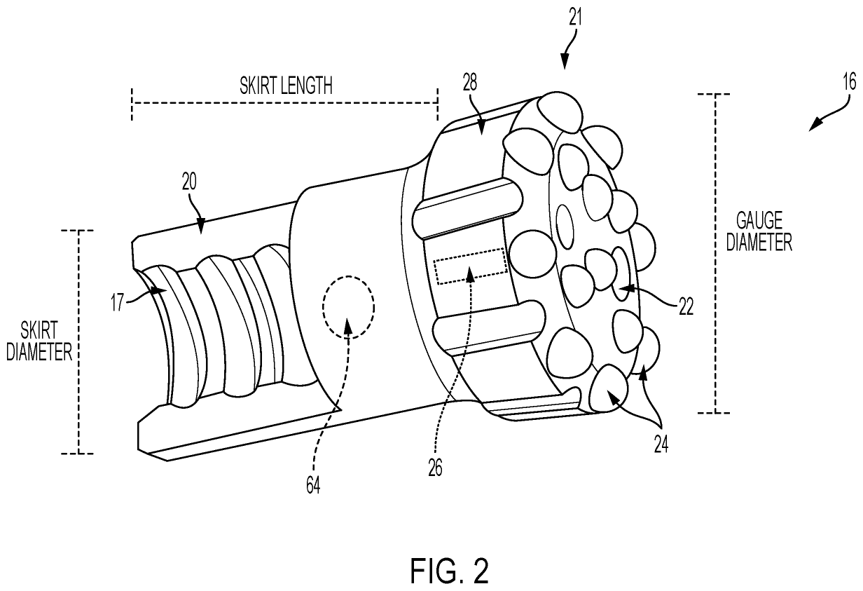

With reference to FIG. 1, a system 10 includes a processor 12 in communication with a robotic arm assembly 14. The processor 12 is configured to control the robotic arm assembly 14 to position a drill bit 16 in a bit holder 18. The term drill bit 16 is intended to encompass any drill bit suitable for reconditioning. In one aspect, the drill bit 16, as shown in FIG. 2, may include a skirt 20, a face 22 and a plurality of button elements 24. The skirt 20, face 22 and button elements 24 may be formed of any suitable material. In one aspect the skirt 20 is formed from steel and the button elements 24 on the face 22 may be formed at least partially from carbide. Similarly, the bit holder 18 is intended to encompass any gripping mechanism that can house or otherwise securely engage the drill bit(s) 16. In at least one aspect, the gripping mechanism (or bit holder) 12 may be a mechanism that holds the drill bit 16 in a particular angular and axial position. In one exemplary aspect, the drill bit 16 may include a notch 26 formed in the back head shoulder 28 of the drill bit 16 to match with a portion of the bit holder 18 to insure proper alignment. In another exemplary aspect, the drill bit 16 can have an internal surface 17 that is engaged by the bit holder 18 when the bit holder is received within the interior of the drill bit. Other orientation arrangements may be derived from the present disclosure.

The processor 12 is also in communication with an imaging assembly, such as, for example, a three-dimensional electronic scanning assembly 30 for generating a 3-D image of the face 22 of the drill bit 16 (including the plurality of buttons 24. The 3-D scanning assembly can comprise a wide variety of imaging technologies. In one aspect, the 3-D scanning assembly may comprise an optical scanning assembly. In another aspect, the 3-D scanning assembly may include a laser scanning assembly. In one aspect, the 3-D electronic scanning assembly 30 takes a current image 32 (e.g., current scan) of the drill bit 16 once it is positioned in the bit holder 18 and in an angular and axially correct position. Although a 3D scanning assembly 30 is disclosed herein in detail, it is contemplated that other imaging devices can be used to produce current images 32 as further disclosed herein. The processor 12 stores the current image 32 (e.g., current scan) in an electronic memory device 34. In the current disclosure, it is understood that any description of a “current scan” is equally applicable to other image formats (other types of “current images”), even though such formats may not be produced by a scanning process. In one aspect, the current image 32 may comprise a complete three dimensional imaging scan. In another aspect, the current image 32 may comprise merely dimensional measurements or data representing the current condition of the drill bit 16. In still other aspects, the current image 32 can comprise one or more two-dimensional images. The electronic memory device 34 is intended to encompass any electronic storage device including, but not limited to, a memory stick, a memory device mounted directly to the drill bit 16, a database stored on a computing device or computer network, or a cloud storage device.

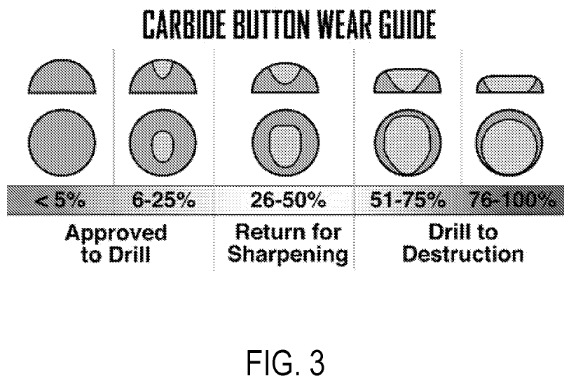

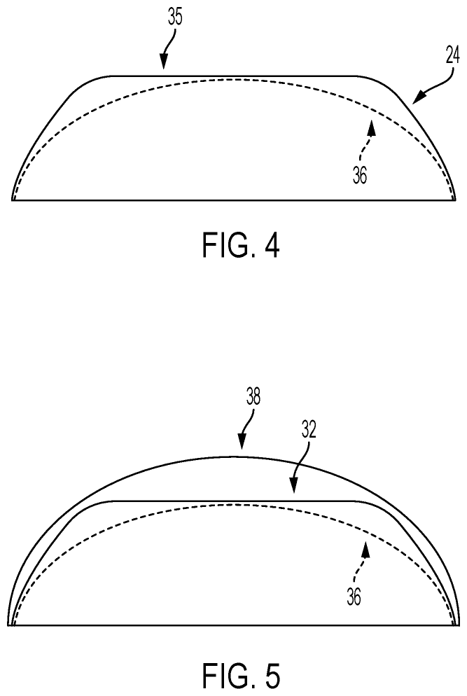

Drill bits 16 experience wear during use. The carbide on the buttons 24 can become flattened in areas that diminish performance. An exemplary illustration of different use/wear profiles is depicted in FIG. 3. When the drill bits 16 are sent for reconditioning, the present system uses the current scan 32 to calculate a plurality of minimum button face material removal profiles 36. In one aspect, the button face material may comprise carbide. A single minimum button face material profile 36 is schematically depicted in FIG. 4. The minimum button face material removal profile 36 is a profile that maximizes the button 24 performance shape while minimizing the button material removal. Since the drill bit 16 includes a plurality of buttons 24, a minimum button face material removal profile 36 can be generated for each button. More particularly, the removal profile 36 can be based on an evaluation of the plurality of buttons of the drill bit to produce optimal performance and optimal product life. As shown, each button 24 can have a wear zone 35 where the button has experienced wear. In another aspect, the current scan 32 can be compared to a historical image 38 (e.g., historical scan) to generate the minimum button face material removal profiles 36 as shown in FIG. 5. The use of a historical image 38 (e.g., historical scan) allows a calculation of the location of wear as well as an efficient way to maximize retention of material such as carbide in non-wear areas. In the current disclosure, it is understood that any description of a “historical scan” is equally applicable to other image formats (other types of “historical images”), even though such formats may not be produced by a scanning process.

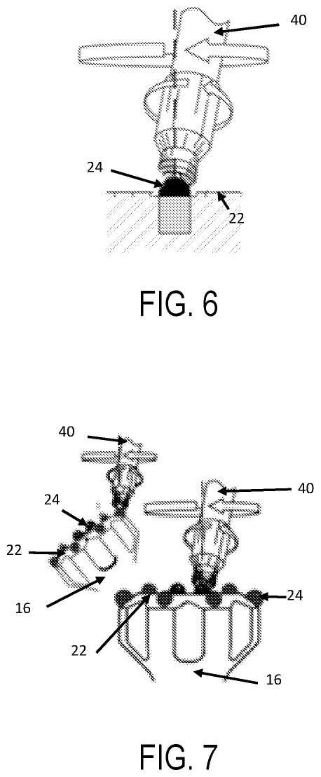

The historical scans 38 may be stored on the electronic memory device 34. The historical scans 38 may comprise scans from previous drill bit reconditioning. In the case wherein the processor scans a drill bit 16 for reconditioning for the first time, the historical scan 38 may comprise an optimal or designed part shape such as a CAD drawing. Once the minimum button face material removal profiles 36 have been generated (either by the current scan 32 alone or by comparison of the current scan 32 with a historical scan 38), the processor communicates with a bit grinder assembly 40 to grind the face 22 of the drill bit 16 in accordance with the minimum button face material removal profiles 36 (see FIGS. 6 and 7). In at least one aspect, the processor 12 communicates with the 3-D scanning assembly 30 to scan the face 22 of the drill bit 16 after grinding to generate a post-grinding scan 42. The processor 12 can then store the current scan 22 and the post-grinding scan 42 in the electronic memory device 34 such that wear can be monitored and predicted over multiple refurbishments of the drill bit 16. The processor 12, using this recorded history, can determine various properties (e.g., quality factors) of the drill bit 16. For example, the processor 12 can predict and produce an output (e.g., use/wear profile or factor 44) indicative of the remaining number of refurbishments the drill bit 16 has left in its lifespan. Additionally, or alternatively, the processor can produce an output (e.g., grade value 46) indicative of the suitability of the post-grinding button shape for particular mining operations. The processor can be further configured to produce an output indicative of an end of service condition, which occurs when the post-grinding button shape is not suited for a particular mining operation and/or no further reconditioning of the drill bit is available. In further aspects, the processor 12 can be configured to determine a projected life span 48 that is indicative of a prediction of the remaining life span of the drill bit 16. It is contemplated that the processor 12 can evaluate the drill bit 16 (based on standards or minimum acceptable limits) to identify excessive button fractures, excessive buttons missing, over drilled conditions wherein excessive grinding prohibits reshaping, inadequate steel present to support buttons, insufficient gauge diameter to support reshaping, and steel failures. This further allows the processor 12 to identify and separate warranty conditions from misuse or abuse performed by the operators. Although the system 10 has been primarily been described as refurbishment through grinding of the buttons on the face 22 of the drill bit 16, the processor 12, in some aspects, may additionally use the images (e.g., scans) 32, 38, 42 to determine a steel removal profile 50 and communicate with a steel removal apparatus (e.g., an acid bath 52, or other apparatus that accommodates a suitable steel removal technique), to refurbish the non-carbide portions of the drill bit 16. The processor 12, based on the current scan 32, may ascertain root causes behind various types of damage, in order to identify manage inventory, invoicing, regular use, misuse/abuse, manufacturing defects, or other opportunities to support continuous improvement.

In one aspect, the system 10 may further include an identification scanner 54 for scanning an identification 56 on the drill bit 16. The identification 56 may comprise any of a number of mechanisms or structures for giving individual drill bits 16 unique identifiers to allow the drill bits to be quickly and accurately identified when they come in for refurbishing. The identification 56 can include, for example and without limitation, an engraved serial number, RFID tags embedded in the drill bit 16, near field communications tags, and even QR codes etched or printed on the drill bit 16. Similarly, the identification scanner 54 can comprise an optical scanner, an RFID scanner, a near field communications scanner or a QR code scanner to compliment the technology utilized to add the identification 56 to the drill bit 16. The scans 32, 38, 42 may be stored on the electronic memory device 34 associated with the identification 56 as well as the current outputs 44, 46, and/or 48, which can be indicative of the remaining number of refurbishments available for a drill bit, the suitability of the drill bit for a particular mining operation, and/or the projected life of the drill bit.

In another aspect, the system 10 may further include an inventory database 58 that may be the same or independent from the electronic memory device 34. The inventory database 58 allows for the storage of data for a plurality of drill bits 16, their identification 56, their images (e.g., scans) 32, 38, 42, and the outputs 44, 46, 48 indicative of properties of the drill bit. In some aspects, the system 10 may be used to assess the wear trajectory and project the total life of a project, thereby allowing project managers to drive inventory replenishment as required. Optionally, the inventory database 58 can be made available to customers to track the status of their inventory and ensure they have enough drill bits 16 of the right grade value 46 to complete their project. Optionally, the system 10 can further store the required number 60 of required drill bits 16 of a given grade value 46 for a given project and automatically reorder new drill bits 16 to ensure the project may be completed without delay. In another aspect, the system 10 may invoice or notify the customer when the required number 60 of drill bits 16 is below or approaching the minimum number to allow the customer to proactively order new bits. In still another aspect, the system 10 can provide a client portal 62 to allow clients in real time to monitor the status of their inventory.

In another aspect of the disclosure, the system 10 may include a grade marking assembly 62 that can place a marker 64 on the drill bit 16. In one aspect the marker 64 may include a paint color, a laser etch, a code (e.g., a QR code), or combinations thereof. In these, non-limiting scenarios, the grade marking assembly 62 may comprise a paint application assembly, a laser etching assembly, or a code (e.g., QR code) application assembly. In some aspects, the marker 64 can be indicative of a size rating of the drill bit, thereby allowing a drill rig operator to determine the suitability of the drill bit for a given drilling operation. In another aspect, the marker 64 can be indicative of a wear condition of the drill bit. In still further aspects, the marker 64 can be indicative of one or more of the determined properties (e.g., number of remaining refurbishments, projected life span, button dimensions, and the like) of the drill bit.

FIG. 8 depicts one exemplary method of drill bit reconditioning and tracking 100. As shown, the method 100 may include positioning a drill bit in a bit holder 102. The method includes scanning the drill bit using 3-D electronic scanning or other optical scanning 104 and storing a current scan in an electronic memory device 106. The method 100 may also include calculating an optimal material removal profile for each button of the drill bit to provide button height consistency. Optionally, the method 100 can include determining a set of minimum button face material removal profiles using the current scan 108, with each profile being associated with a respective button of the drill bit. The method 100 may also include grinding the face of the drill bit based on the optimal (e.g., minimum) material removal profile(s) 110 and saving the current scan as a historical scan 112.

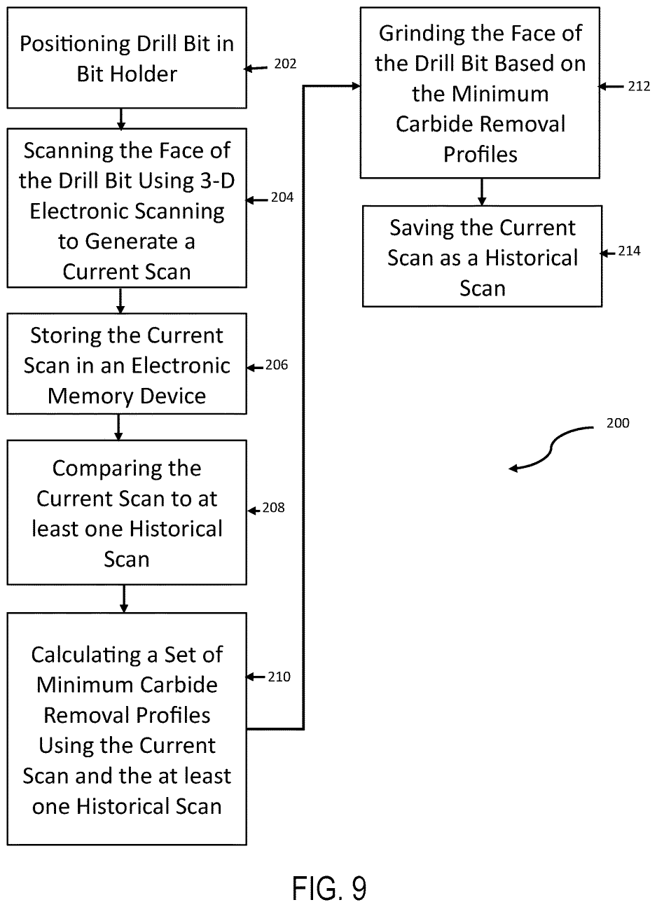

In another aspect of the disclosure shown in FIG. 9, a method of drill bit reconditioning and tracking 200 is illustrated. The method 200 may include positioning a drill bit in a bit holder 202 and scanning the face of the drill bit using 3-D electronic scanning or other imaging scanning to generate a current scan 204. The method 200 may further include storing the current scan in an electronic database 206 and comparing the current scan to at least one historical scan 208. The method 200 may include calculating a set of minimum button face material removal profiles using the current scan and the at least on historical scan 210 and grinding the face of the drill bit based on the minimum button face material removal profiles 212. Finally the method 200 may include saving the current scan as a historical scan 214.

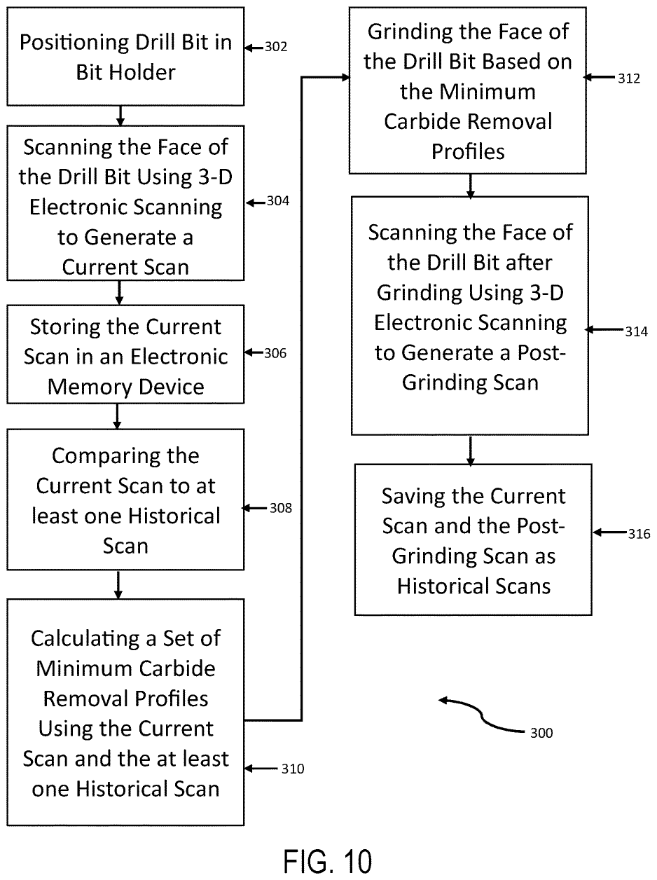

In another aspect of the disclosure shown in FIG. 10, a method of drill bit reconditioning and tracking 300 is illustrated. The method 300 may include positioning the drill bit in the bit holder 302 and scanning the face of the drill bit using 3-D electronic scanning or other imaging scanning to generate a current scan 304. The method 300 may include storing the current scan in an electronic memory device 306. The method may include comparing the current scan to at least one historical scan 308 and calculating a set of minimum button face material removal profiles using the current scan at the at least one historical scan 310. The method 300 may further include grinding the face of the drill bit based on the minimum button face material removal profiles 312. The method 300 may further include scanning the face of the drill bit after grinding using 3-D electronic scanning or other imaging technology to generate a post grinding scan 314 and saving the current scan and the post grinding scan as historical scans 316.

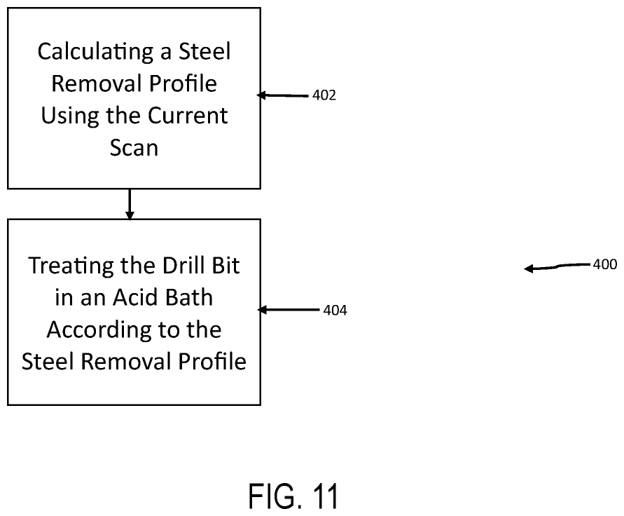

FIG. 11 depicts an additional aspect of the disclosure that may be utilized along with any of the various methods described herein. The additional method aspect 400 may include calculating a steel removal profile using the current scan 402 and treating the drill bit in an acid bath or using other steel reconditioning methodologies according to the steel removal profile 404.

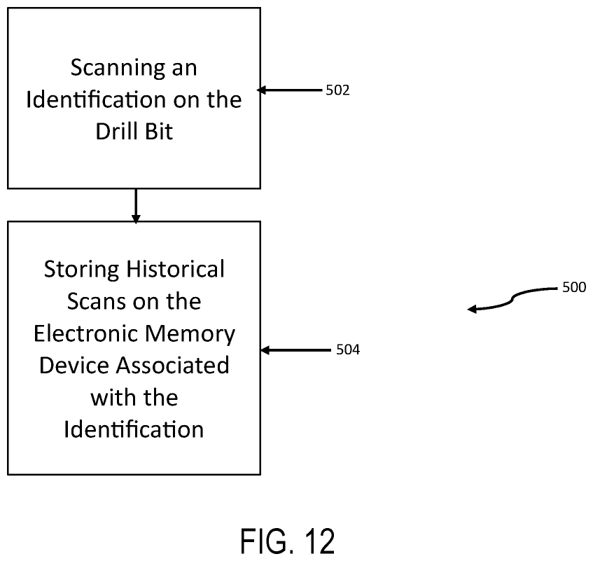

FIG. 12 depicts an additional aspect of the disclosure that may be utilized along with any of the various methods described herein. The additional method aspect 500 may include scanning an identification on the drill bit 502 and storing the historical scans on the electronic memory device associated with the identification 504.

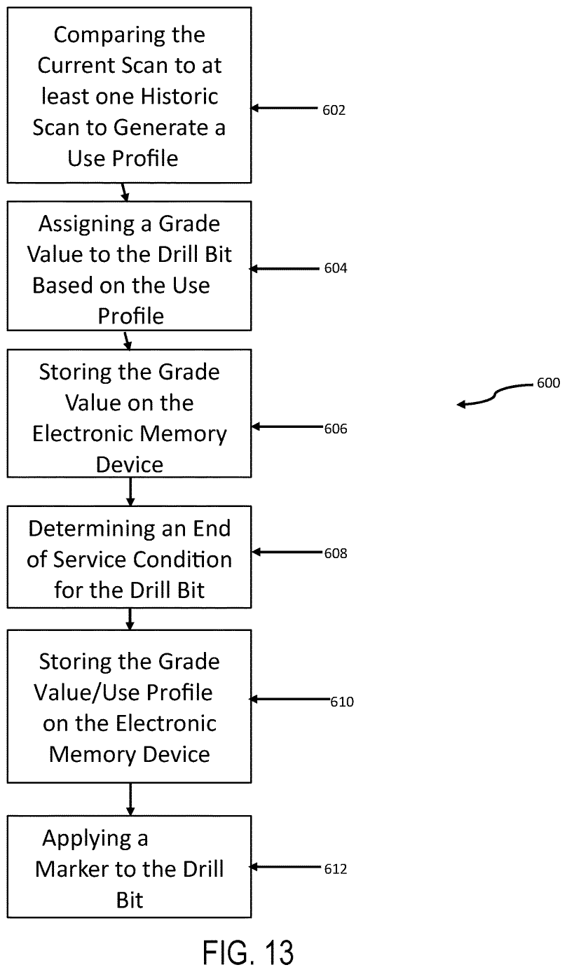

FIG. 13 depicts an additional aspect of the disclosure that may be utilized along with any of the various methods described therein. The additional method aspect 600 may include comparing the current scan to at least one historic image (e.g., historic scan) to generate a use profile 602. The method 600 may also include assigning a grade value to the drill bit based on the use profile 604. The method 600 may include storing the grade value on the electronic memory device 606 and determining an end of service condition for the drill bit 608. The method 600 may also include storing the grade value and use profile on the electronic memory device 610 and applying a marker to the drill bit 612 that can be indicative of a size and/or wear status of the drill bit.

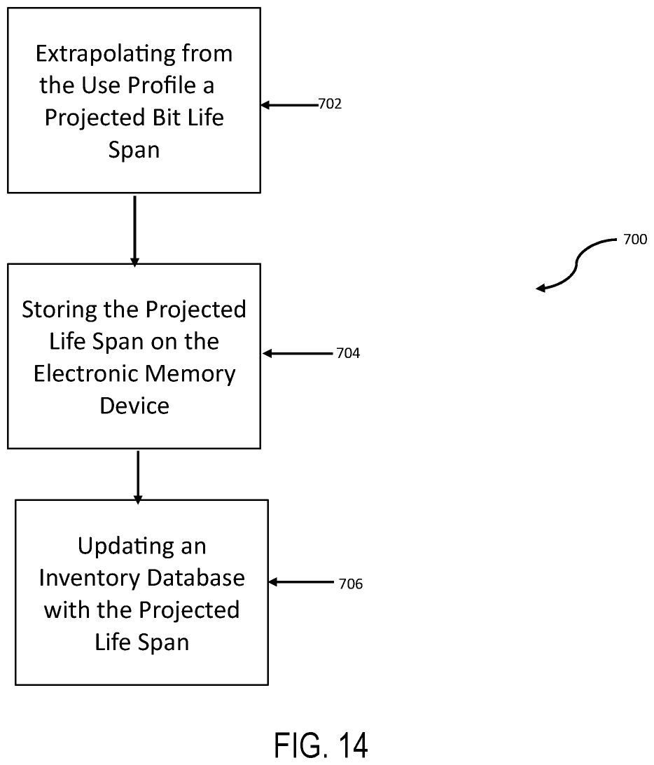

FIG. 14 depicts an additional aspect of the disclosure that may be utilized along with any of the various methods described therein. The additional method aspect 700 may include extrapolating from the use profile a projected lifespan 702 and storing the projected life span on the electronic memory device 704. The method 700 may further include updating an inventory database with the projected life span 706.

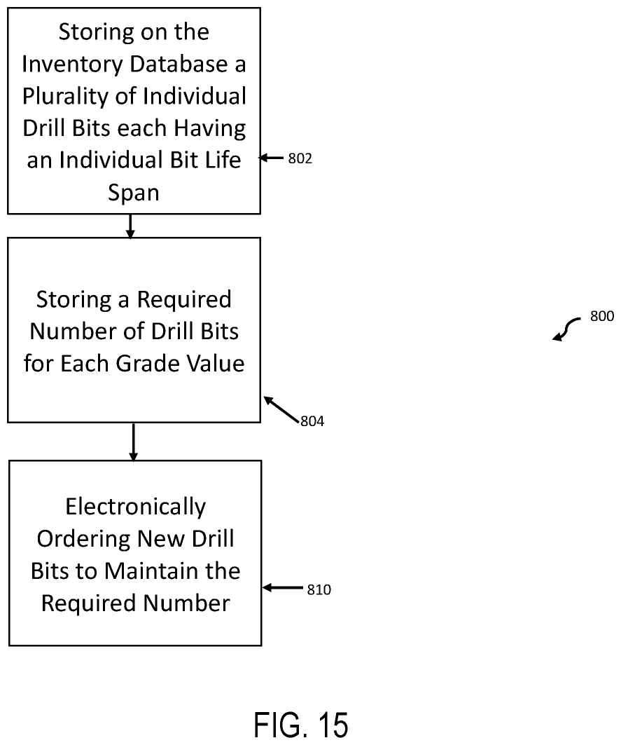

FIG. 15 depicts an additional aspect of the disclosure that may be utilized along with any of the various methods described therein. The additional method aspect 800 may include storing on an inventory database a plurality of individual drill bits each having an individual drill bit life span 802. The method 800 may further include storing a required number of drill bits for each grade value 804. In another aspect the required number of drill bits is intended to be the number of drill bits of a particular grade value projected to be needed to complete a drilling project of a given profile. This may include, but is not limited to, the material drilled, the type of operation, the depth of drilling, and the number of drill sites. In still another aspect, the data may be utilized to report, evaluate and extrapolate needs of the drilling operators and link this information to inventory management. In still another aspect the method 800 may include electronically ordering new drill bits to maintain the required number of a particular grade 810.

Optionally, in some aspects, method can include direct communication with a drill rig operator or other individual involved with the operation or management of a drill site. For example, in some aspects, the required number of drill bits can be the number of drill bits of a particular grade value a operator (e.g., customer) has requested. The method 800 may further include reporting the inventory database to an operator (e.g., customer). This may allow an operator (e.g., customer) of an active drilling operation to actively monitor their inventory and place orders for new drill bits as their operations dictate. In an alternate aspect of the method, the method 800 may include providing reorder information to the operator (e.g., customer). In this aspect, the reconditioning and inventory service may be provided with the operator's (e.g., customer's) drilling operation requirements and proactively provide reorder recommendations to the operator (e.g., customer). This further simplifies the active drill operations of an operator (e.g., customer) by allowing them to concentrate on the drilling operations rather than requiring them to actively monitor their inventory.

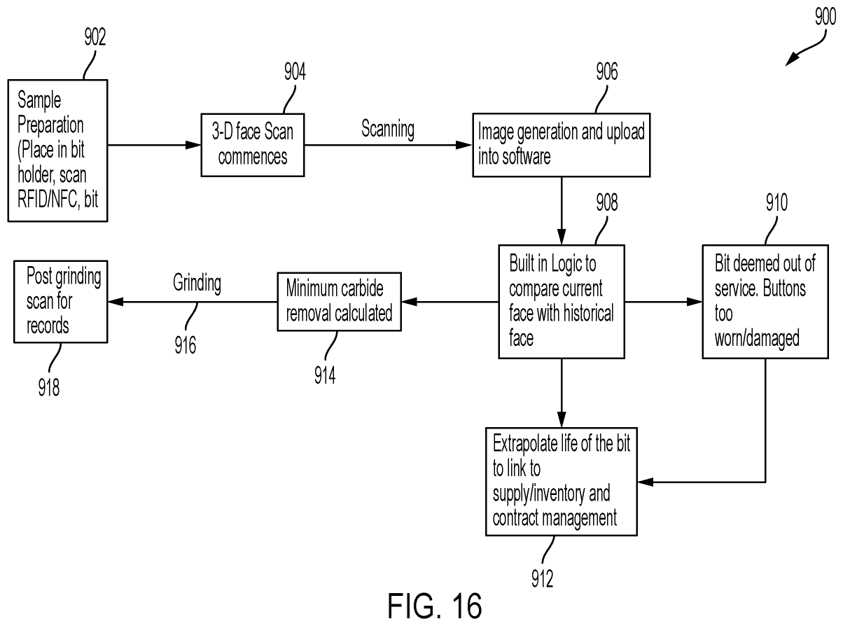

Referring now to FIG. 16, which is another aspect of a method of drill bit reconditioning and inventory tracking 900 according the disclosure. The method 900 may include sample preparation 902. This may include, but is not limited to placing a drill bit in a bit holder, scanning the RFID/NFC identification of the particular drill bit, and identifying the particular drill bit's files in an electronic memory device and/or an inventory database. The method 800 may include 3-D face scanning, optical scanning, or any electronic imaging of the particular drill bit 904. The method 900 may include image generation of the scan and uploading the image generation into a software program 906. The method 900 may include using built in logic of the software to compare the current scan of the drill bit with a historical face scan 908. The historical face scan may include, but is not limited to, a previous scan of the particular drill bit, an engineering technical model (such as a CAD drawing) of the drill bit as designed, or a generated optimized profile based on the current scan alone. The method 900 may include determining if the particular drill bit is deemed out of service 910 if the buttons are too worn or damaged or the metal portion, such as the skirt or metal portion of the face have sustained unrepairable damage. If an end of service condition is determined the drill bit is discarded. If it is determined that an end of service condition does not exist, the method 900 includes extrapolating the remaining life of the drill bit and linking that remaining life to supply, inventory, and/or contract management 912. As discussed above, this may include a variety of fashions of informing the customer of the status of their inventory. The method includes calculating a minimum button face material removal of each button the particular drill bit 914 and grinding each button of the particular drill bit in accordance with the calculated minimum button face material removal calculation 916. In at least one aspect, the method 900 may also include scanning the drill bit post grinding an updating the records for the particular drill bit with the post-grinding scan 918.

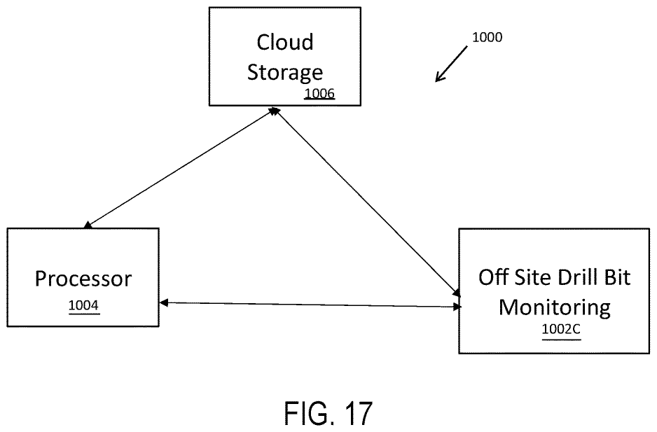

Referring now to FIG. 17, which is another aspect of a method of drill bit reconditioning and inventory tracking 1000 according the disclosure. The method 1000 may include off-site drill bit monitoring 1002. The off-site drill bit monitoring 1002 may include other data sets tracking drill meters and rock types drilled. This can be from the drill itself of from another computer system. The method may include an apparatus 1004 that identifies the serial number on the bit when it goes on the drill and when it's removed, along with number of holes, drill meters, and other information from the drill or geological information. In at least one aspect the off-site drill bit monitoring 1002 may communicate with the inventory processor 1004 by way of cloud storage 1006 communication. In other aspects, the off-site drill bit monitoring 1002 may communicate directly with the inventory processor 1004.

It should be understood that combinations of the various aspects of each of the different embodiments disclosed herein are also contemplated.

It should be further understood that each method step recited herein can be performed by one or more processors, which can be provided within or in association with one or more computing devices. It is further contemplated that the one or more computing devices can further comprise one or more memories storing executable instructions that, when executed by the one or more processors, allow for performance of one or more of the disclosed method steps.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A system comprising: a reader configured to detect an identifier associated with a drill bit, wherein the identifier is indicative of an identity of the drill bit; a computing device in communication with the reader and configured to receive an input from the reader that corresponds to the identifier associated with the drill bit, wherein the computing device is configured to receive and store data associated with the drill bit; and an imaging device that is in communication with the computing device, wherein the imaging device is configured to acquire at least one image of the drill bit.

Aspect 2: The system of aspect 1, wherein the identifier comprises a serial number associated with the drill bit.

Aspect 3: The system of aspect 1 or aspect 2, wherein the drill bit is percussive bit. Optionally, in these aspects, the drill bit is a down-the-hole percussive bit, a top hammer bit. Optionally, in these aspects, the drill bit is a rotary-percussive drill bit.

Aspect 4: The system of any one of aspects 1-3, wherein the at least one image comprises at least one two-dimensional image, and wherein the imaging device comprises a camera.

Aspect 5: The system of any one of aspects 1-3, wherein the computing device is configured to: receive the at least one image of the drill bit; and determine, based at least in part on the acquired at least one image of the drill bit, a condition or attribute of the drill bit.

Aspect 6: The system of any one of the preceding aspects, wherein the imaging device is configured to generate a three-dimensional representation of the drill bit.

Aspect 7: The system of aspect 6, wherein the imaging device comprises an image scanner.

Aspect 8: The system of aspect 7, wherein the image scanner comprises a memory storing a plurality of three-dimensional representations associated with respective serial numbers of drill bits, and wherein the image scanner has a processor that is configured to determine a three-dimensional representation of the plurality of three-dimensional representations that corresponds to the detected serial number of the drill bit.

Aspect 9: The system of any one of aspects 5-8, further comprising a drill bit sharpening apparatus in communication with the computing device, wherein the drill bit sharpening apparatus is configured to receive an output from the computing device that is indicative of the identifier associated with the drill bit.

Aspect 10: The system of any one of aspects 1-9, further comprising a drill rig controller in communication with the computing device, wherein the computing device is configured to generate a time stamp corresponding to a time of a detection of the identifier associated with the drill bit, and wherein the drill rig controller is configured to provide one or more inputs to the computing device.

Aspect 11: The system of aspect 10, wherein the drill rig controller is configured to: determine a number of meters drilled by the drill bit; and provide, to the computing device, an instruction to update a stored informational profile associated with the drill bit to reflect the determined number of meters drilled by the drill bit.

Aspect 12: The system of aspect 10 or aspect 11, wherein the drill rig controller is configured to instruct the computing device to update a stored informational profile associated with the drill bit to indicate a total number of times the drill bit has been used in a drilling operation.

Aspect 13: The system of aspect 11 or aspect 12, further comprising a remote computing device that stores the informational profile associated with the drill bit, and wherein the remote computing device is in wireless communication with the drill rig controller.

Aspect 14: A method comprising: using the system of any one of the preceding aspects to identify a drill bit; and optionally, using the system to determine a condition or attribute of the drill bit.

Aspect 15: A system comprising: an imaging device configured to acquire at least one image of a face portion of a drill bit, the face portion of the drill bit having a face surface and a plurality of buttons projecting from the face surface; and a computing device in communication with the imaging device, and wherein the computing device is configured to update a stored informational profile of the drill bit based on the at least one image, wherein the stored informational profile includes geometric, wear, usage, and/or condition information, optionally: wherein the computing device is configured to determine a three-dimensional representation of the face portion of the drill bit based at least in part on the at least one acquired image of the face portion of the drill bit, and wherein the computing device is further configured to determine or update a stored informational profile of the drill bit based upon the three-dimensional representation of the face portion of the drill bit.

Aspect 16: The system of aspect 15, wherein the stored informational profile comprises wear-related volumetric loss, wherein the computing device is configured to further determine, based on the wear-related volumetric loss, a determined amount of button material to be removed at one or more buttons of the plurality of buttons of the drill bit.

Aspect 17: The system of aspect 15 or aspect 16, wherein the computing device is configured to determine optimal shapes for the plurality of buttons, and wherein the computing device is configured to determine an amount of button material to be removed to produce the optimal shapes for one or more buttons of the plurality of buttons.

Aspect 18: The system of aspect 17, wherein the system further comprises a drill bit sharpening apparatus in communication with the computing device, and wherein the computing device is configured to determine, based on the determined amount of button material to be removed at each of the one or more buttons, optimal grinding parameters for each of the one or more buttons.

Aspect 19: The system of any one of aspects 15-18, wherein, based on the at least one image, the computing device is configured to determine a gauge diameter of the drill bit.

Aspect 20: The system of aspect 19, wherein the stored informational profile of the drill bit comprises one or more failure codes, and, optionally, wherein the computing device is configured to associate the one or more failure codes with the measured gauge diameter of the drill bit.

Aspect 21: The system of aspect 19 or aspect 20, wherein the computing device is configured to determine a need for subjecting the drill bit to a steel removal process, and wherein, optionally, the computing device is configured to determine the need for subjecting the drill bit to a steel removal process by comparing the at least one image to an optimal face profile associated with the drill bit.

Aspect 22: The system of aspect 21, wherein the computing device is configured to determine a category of acid bath steel removal to which the drill bit should be subjected.

Aspect 23: The system of aspect 22, wherein the computing device is configured to select an optimal category of acid bath steel removal from among a plurality of categories of acid bath steel removal, wherein each category is associated with a different duration of acid bath.

Aspect 24: The system of aspect 19, further comprising a marking apparatus that is in communication with the computing device and configured to receive an input from the computing device that is indicative of a determined gauge diameter of the drill bit, and wherein the marking apparatus is configured to apply a mark or color to the drill bit based on the determined gauge diameter of the drill bit.

Aspect 25: The system of any one of aspects 19-24, wherein the computing device is configured to associate the determined gauge diameter of the drill bit with an identity of the drill bit.

Aspect 26: The system of any one of aspects 15-25, wherein the computing device is configured to determine a presence of one or more condition signatures within the at least one acquired image and/or the three dimensional representation of the drill bit, and wherein the one or more condition signatures are each indicative of a condition associated with information in the stored informational profile of the drill bit.

Aspect 27: The system of aspect 26, wherein the one or more condition signatures are indicative of one or more of: broken buttons; lost or missing buttons; over-drilled buttons; portions of the bit body (that supports the buttons) contacting rock (or other formation material); insufficient rotation speed; or excessive rotation speed.

Aspect 28: The system of aspect 26 or aspect 27, wherein the computing device is configured to determine, based upon the one or more condition signatures and the at least one acquired image and/or the three-dimensional representation of the drill bit, characteristics of a previous drilling cycle of the drill bit.

Aspect 29: The system of aspect 28, wherein the characteristics of the previous drilling cycle of the drill bit include a determination of whether the drill bit was operated improperly during the previous drilling cycle.

Aspect 30: The system of aspect 29, wherein the characteristics of the previous drilling cycle of the drill bit include a comparison between a parameter of the drill bit before the previous drilling cycle and the same parameter of the drill bit after the previous drilling cycle.

Aspect 31: The system of any one of aspects 28-30, wherein the computing device is configured to associate the characteristics of the previous drilling cycle with one or more of: a drill operator who participated in the previous drilling cycle; a drill rig that performed the previous drilling cycle; and/or a client account.

Aspect 32: The system of any one of aspects 15-31, further comprising a database in communication with a processor of the computing device, wherein the database comprises images of drill bits that have been classified as properly run or improperly run, wherein the computing device is configured to determine, based upon the at least one acquired image, whether the drill bit was properly run or improperly run during a previous drilling cycle, and wherein the computing device is configured to: assign, to each acquired image, a category indicative of whether the acquired image is associated with a properly run drill bit or an improperly run drill bit; and update the database to include each acquired image and the corresponding assigned category.

Aspect 33: The system of aspect 32, wherein the computing device is further configured to: determine, for any acquired image assigned a category indicative of a properly run drill bit, whether the properly run drill bit experienced accidental damage during the previous drilling cycle; assign, to each acquired image associated with a properly run drill bit that experienced accidental damage, a category indicative of accidental damage to a properly run drill bit; and for each acquired image associated with a properly run drill bit that experienced accidental damage, update the database to include the assigned category indicative of said accidental damage.

Aspect 34: The system of aspect 32 or aspect 33, wherein the computing device is configured to update the database to include, for the stored informational profile of each drill bit of a plurality of drill bits, searchable data indicative of the usage, condition, structure, and/or wear of the drill bit, acquired images of the drill bit, and/or an assigned category of the drill bit.

Aspect 35: The system of aspect 34, wherein the searchable data is indicative of one or more structural conditions of the drill bit.

Aspect 36: The system of aspect 35, wherein the one or more structural conditions include a lost button or a chipped button.

Aspect 37: The system of aspect 18, wherein the computing device is configured to determine the amount of button material to be removed at each of the one or more buttons based on a minimum tolerated gauge diameter at which the drill bit is usable, wherein removal of the determined amount of button material is configured to retain a gauge diameter greater than the minimum tolerated gauge diameter, thereby permitting further wear of the drill bit before the drill bit reaches the minimum tolerated gauge diameter.

Aspect 38: The system of aspect 37, wherein the computing device is configured to determine the amount of button material to be removed based upon a target gauge diameter, wherein removal of the determined amount of button material is configured to provide the target gauge diameter.

Aspect 39: The system of any one of aspects 15-38, wherein the computing device is configured to determine an angular orientation of the drill bit within the imaging device based upon a location of a reference mark on the drill bit during acquisition of the at least one image of the face portion of the drill bit.

Aspect 40: The system of aspect 39, further comprising a marking tool configured to apply the reference mark to the drill bit prior to acquisition of the at least one image of the face portion of the drill bit.

Aspect 41: The system of aspect 40, wherein the marking tool comprises a wire brush, a rotary tool, a stencil, and/or an indentation tool.

Aspect 42: The system of any one of aspects 32-36, wherein the computing device is configured to compare one or more acquired images of the drill bit to one or more images of a reference drill bit associated with a same product number or part number as the drill bit.

Aspect 43: The system of any one of aspects 32-36, further comprising a bit holder that is configured to engage an internal surface of the drill bit to support the drill bit in a fixed axial reference position.

Aspect 44: The system of aspect 18, wherein the stored informational profile comprises forward and radial protrusion measurements of each button of the plurality of buttons, and wherein the computing device is configured to determine, based on the forward and radial protrusion measurements of each button of the plurality of buttons, an optimal forward and radial protrusion measurement that is common to each button of the plurality of buttons, and wherein the computing device is configured to cause the drill bit sharpening apparatus to remove sufficient material of each button of the plurality of buttons such that each button has the optimal forward and radial protrusion measurements.

Aspect 45: The system of any one of aspects 15-44, further comprising a robot that is in communication with the computing device, the robot having a robotic arm that is coupled to the imaging device, wherein the computing is configured to cause the robotic arm to move the imaging device in a pattern that permits acquisition of the at least one image of the drill bit.

Aspect 46: The system of aspect 18, further comprising a robotic arm that is in communication with the computing device and coupled to the drill bit sharpening apparatus, wherein the computing device is configured to cause the robotic arm to move the drill bit sharpening apparatus in a pattern that permits removal of the determined amount of button material of each button of the plurality of buttons.

Aspect 47: The system of aspect 18, wherein the imaging device is configured to acquire images of each respective drill bit of a batch of drill bits in a sequential order, wherein the computing device is configured to associate the images of each respective drill bit with an identifier of the batch and to determine an amount of button material to be removed for each button of each respective drill bit, wherein the drill bit sharpening apparatus is configured to sequentially determine, for each respective drill bit of the batch, optimal grinding parameters for each of the buttons of the drill bit, and wherein the drill bit sharpening apparatus is configured to determine, based on the sequential order of drill bits of the batch of drill bits, a sequence of sharpening actions needed to remove the determined amount of button material from each button of the plurality of drill bits, and wherein the drill bit sharpening apparatus is configured to associate the determined sequence of sharpening actions with the identifier of the batch.

Aspect 48: The system of any one of aspects 15-47, wherein the computing device is configured to associate a serial number of the drill bit with drill bit condition information and to update the drill bit condition information, wherein the drill bit condition information includes one or more of: number of sharpenings; current gauge diameter; damage progression; usage evaluation of previous run of the drill bit; usage evaluation of complete life of the drill bit.

Aspect 49: The system of aspect 48, wherein the computing device is configured to determine whether the drill bit should be retired, and wherein, for any drill bit that should be retired, the computing device is configured to determine, based on a usage evaluation of a complete life of the drill bit, a classification of the lifetime usage of the drill bit.

Aspect 50: The system of aspect 48 or aspect 49, wherein the system further comprises a reader configured to detect an identifier associated with a drill bit, wherein the identifier is indicative of an identity of the drill bit, and wherein the computing device in communication with the reader and configured to receive an input from the reader that corresponds to the identifier associated with the drill bit.

Aspect 51: The system of any one of aspects 48-50, further comprising a drill rig controller in communication with the computing device, wherein the drill rig controller is configured to provide one or more inputs to the computing device, and wherein the computing device is configured to associate drilling information received from the drill rig controller with the serial number of the drill bit.

Aspect 52: The system of aspect 51, wherein the drilling information that is associated with the serial number of the drill bit includes one or more of: penetration rate; rig identification; rig operator identification; or a number of meters drilled by the drill bit.

Aspect 53: The system of aspect 52, wherein the computing device is configured to update a profile assigned to the drill bit to include the drilling information associated with the serial number of the drill bit and the drill bit condition information associated with the drill bit.

Aspect 54: The system of any one of aspects 1-13, wherein the drill bit is percussive bit. Optionally, in these aspects, the drill bit is a down-the-hole percussive bit, a top hammer bit. Optionally, in these aspects, the drill bit is a rotary-percussive drill bit.

Aspect 55: The system of aspect 7, wherein the computing device is configured to determine a condition of the drill bit, wherein the condition of the drill bit is assigned a category indicative of determined physical, wear, damage, or usage properties of the drill bit, and wherein, optionally, the images of the drill bit are discarded.

Aspect 56: The system of any one of aspects 15-44, further comprising a robotic arm that is in communication with the computing device and coupled to the drill bit, wherein the computing device is configured to cause the robotic arm to move the drill bit in a pattern relative to the imaging device to permit acquisition of the at least one image of the drill bit.

Aspect 57: The system of aspect 18, further comprising a robotic arm that is in communication with the computing device and coupled to the drill bit, wherein the computing device is configured to cause the robotic arm to move the drill bit in a pattern relative to the drill bit sharpening apparatus to permit removal of the determined amount of button material of each button of the plurality of buttons.

Aspect 1A: A method of drill bit reconditioning and tracking comprising: positioning a drill bit in a bit holder; scanning a face of said drill bit using three-dimensional electronic scanning to generate a current scan; optionally, storing (e.g., temporarily storing) said current scan in an electronic memory device; calculating a set of minimum button face material removal profiles using said current scan; grinding said face of said drill bit based on said calculated minimum button face material removal profiles; and, optionally, saving said current scan on said electronic memory device as additional historical scans.

Aspect 2A: The method of drill bit reconditioning and tracking according to aspect 1A, further comprising: comparing said current scan to at least one historical scan; and calculating a set of minimum button face material removal profiles using said current scan and said at least one historical scan.

Aspect 3A: The method of drill bit reconditioning and tracking according to aspect 2A, further comprising: scanning said face of said drill bit after said grinding using said three-dimensional electronic scanning to generate a post-grinding scan; uploading said post-grinding scan to said electronic memory device; and saving said post-grinding scan on said electronic memory device as additional historical scan.

Aspect 4A: The method of drill bit reconditioning and tracking according to aspect 2A or aspect 3A, wherein said at least one historical scan comprises a computer aided design image.

Aspect 5A: The method of drill bit reconditioning according to any one of aspects 1A-4A, further comprising: calculating a steel removal profile; and treating said drill bit in an acid bath according to said steel removal profile.

Aspect 6A: The method of drill bit reconditioning and tracking according to any one of aspects 3A-5A, further comprising: scanning an identification on said drill bit; and storing said additional historical scans in said electronic memory device associated with said identification.

Aspect 7A: The method of drill bit reconditioning and tracking according to aspect 6A, wherein said identification comprises a radio frequency identification.

Aspect 8A: The method of drill bit reconditioning and tracking according to aspect 6A, wherein said identification comprises a near field communication.

Aspect 9A: The method of drill bit reconditioning and tracking according to any one of aspects 1A-8A, wherein said three-dimensional electronic scanning comprises optical scanning.

Aspect 10A: The method of drill bit reconditioning and tracking according to any one of aspects 1A-9A, wherein said three-dimensional electronic scanning comprises laser scanning.

Aspect 11A: The method of drill bit reconditioning and tracking according to any one of aspects 2A-10A, further comprising: comparing said current scan to said at least one historic scan to generate a use/wear profile; assigning a grade value to said drill bit based on said use/wear profile; and storing said grade value on said electronic memory device.

Aspect 12A: The method of drill bit reconditioning and tracking according to aspect 11A, further comprising: determining an end of service condition for said drill bit based on said grade value; and storing said end of service condition on said electronic memory device.

Aspect 13A: The method of drill bit reconditioning and tracking according to any one of aspects 3A-12A, further comprising: comparing said post-grinding scan to said at least one historic scan to generate a use/wear profile; and assigning a grade value to said drill bit based on said use/wear profile; and storing said grade value on said electronic memory device.

Aspect 14A: The method of drill bit reconditioning and tracking according to aspect 13A, further comprising: applying a grade marker to said drill bit based on said grade value.

Aspect 15A: The method of drill bit reconditioning and tracking according to aspect 14A, wherein said grade marker comprises a paint color.

Aspect 16A: The method of drill bit reconditioning and tracking according to aspect 14A, wherein said grade marker comprises a laser etching.

Aspect 17A: The method of drill bit reconditioning and tracking according to aspect 14A, wherein said grade marker comprises a QR code.

Aspect 18A: The method of drill bit reconditioning and tracking according to any one of aspects 13A-17A, further comprising: extrapolating from said grade value a projected bit life span of said drill bit; and storing said projected bit life span on said electronic memory device.

Aspect 19A: The method of drill bit reconditioning and tracking according to aspect 18A, further comprising: updating an inventory database with said projected bit life span.

Aspect 20A: The method of drill bit reconditioning and tracking according to aspect 19A, wherein said inventory database comprises a plurality of individual drill bits each having an individual bit life span.

Aspect 21A: The method of drill bit reconditioning and tracking according to aspect 20A, further comprising: storing a required number of drill bits for each grade value; and electronically ordering new drill bits to maintain said required number of drill bits for each grade value.

Aspect 22A: The method of drill bit reconditioning and tracking according to aspect 20A or aspect 21A, further comprising: reporting said inventory database to a customer.

Aspect 23A: The method of drill bit reconditioning and tracking according to any one of aspects 20A-22A, further comprising: providing reorder recommendations to a customer based on said inventory database.

Aspect 24A: A system for reconditioning drill bits and tracking inventory comprising: an electronic scanning assembly; a robotic arm assembly; a bit grinder assembly; an electronic memory device; an inventory database; and a processor in communication with said electronic scanning assembly, said robotic arm assembly, said bit grinder assembly, said electronic memory device, and said inventory database, wherein said processor is configured to: operate said robotic arm assembly to position a drill bit in a bit holder; operate said electronic scanning assembly to scan a face of said drill bit to generate a current scan; store said current scan in an electronic memory device; calculate a minimum button face material removal profile using said current scan; control said bit grinder assembly to grind said face of said drill bit based on said calculated minimum button face material removal profile; and save said current scan on said electronic memory device as a historical scan.

Aspect 25A: The system for reconditioning drill bits according to aspect 24A, wherein said processor is further configured to: operate said electronic scanning assembly to scan said face of said drill bit to generate a post-grinding scan; upload said post-grinding scan to said electronic memory device; and save said current scan and said post-grinding scan on said electronic memory device as historical scans.

Aspect 26A: The system for reconditioning drill bits and tracking inventory according to aspect 24A or aspect 25A, further comprising: an identification scanner, wherein said processor is further configured to: operate said identification scanner to scan an identification on said drill bit; and store said identification and said historical scans on said electronic memory device in a linked fashion.

Aspect 27A: The system for reconditioning drill bits and tracking inventory according to aspect 26A, wherein said identification scanner comprises a radio frequency identification scanner.

Aspect 28A: The system for reconditioning drill bits and tracking inventory according to aspect 26A, wherein said identification scanner comprises a near field communication scanner.

Aspect 29A: The system for reconditioning drill bits and tracking inventory according to aspect 24A, wherein said electronic scanning assembly comprises an optical scanning assembly.

Aspect 30A: The system for reconditioning drill bits and tracking inventory according to aspect 24A, wherein said electronic scanning assembly comprises an laser scanning assembly.

Aspect 31A: The system for reconditioning drill bits and tracking inventory according to any one of aspects 26A-30A, wherein said processor is further configured to: compare said current scan to at least one historical scan to generate a use/wear profile; assign a grade value to said drill bit based on said use/wear profile; and store said identification and said grade value on said inventory database in a linked fashion.

Aspect 32A: The system for reconditioning drill bits and tracking inventory according to aspect 31A, wherein said processor is further configured to: determine an end of service condition for said drill bit based on said grade value; and store said end of service condition on said inventory database.

Aspect 33A: The system for reconditioning drill bits and tracking inventory according to any one of aspects 25A-32A, wherein said processor is further configured to: compare said post-grinding scan to at least one of said historical scans to generate a use/wear profile; assign a grade value to said drill bit based on said use/wear profile; and store said grade value on said inventory database.

Aspect 34A: The system for reconditioning drill bits and tracking inventory according to aspect 33A, wherein said processor is further configured to: utilize said robotic arm assembly to apply a grade marker on said drill bit based on said grade value.

Aspect 35A: The system for reconditioning drill bits and tracking inventory according to aspect 34A, wherein said grade marker is one of a paint color, a laser etch, and a QR code.

Aspect 36A: The system for reconditioning drill bits and tracking inventory according to any one of aspects 33A-35A, further comprising: a paint application assembly; and wherein said processor is further configured to: associate said grade value to a first color; and operate said paint application assembly to apply said first color to said drill bit.

Aspect 37A: The system for reconditioning drill bits and tracking inventory according to any one of aspects 33A-36A, further comprising: a laser etching assembly; and wherein said processor is further configured to: operate said laser etching assembly to apply etch said grade value onto said drill bit.

Aspect 38A: The system for reconditioning drill bits and tracking inventory according to any one of aspects 33A-37A, wherein said processor is further configured to: extrapolate a projected bit life span of said drill bit from said use/wear profile; and store said projected bit life span on said inventory database.

Aspect 39A: The system for reconditioning drill bits according to aspect 38A, wherein said inventory database comprises identities of a plurality of drill bits each having a stored projected bit life span.

Aspect 40A: The system for reconditioning drill bits and tracking inventory according to aspect 39A, further comprising: an client internet portal in communication with said inventory database.

Aspect 41A: The system for reconditioning drill bits and tracking inventory according to aspect 39A, wherein said processor is further configured to: store a required number of drill bits for each grade value; and order new drill bits to maintain said required number of drill bits for each grade value.

Aspect 42A: The system for reconditioning drill bits and tracking inventory according to any one of aspects 24A-41A, wherein processor is further configured to: utilize said electronic scanning assembly to orientate said bit grinder assembly.

Aspect 1B: A system comprising:
an imaging device configured to acquire data associated with a face portion of a drill bit, the face portion of the drill bit having a face surface and a plurality of buttons projecting from the face surface; and
a computing device in communication with the imaging device,
wherein the computing device is configured to:
   receive data associated with the face portion of the drill bit from the imaging device;
   determine, based on the data received from the imaging device, an informational profile of the face portion of the drill bit, wherein the informational profile includes geometric, wear, usage, and/or condition information.

Aspect 2B: The system of claim 1B, wherein the informational profile of the face portion of the drill bit comprises wear-related volumetric loss, wherein the computing device is configured to further determine, based on the wear-related volumetric loss, an amount of button material to be removed at one or more buttons of the plurality of buttons of the drill bit.

Aspect 3B: The system of claim 2B, wherein the data received from the imaging device comprises at least one image of the face portion of the drill bit.

Aspect 4B: The system of claim 3B, wherein the imaging device comprises an image scanner, wherein the at least one image of the drill bit comprises a 3D scan of the face portion of the drill bit.

Aspect 5B: The system of any one of aspects 2B-4B, wherein the determined amount of button material to be removed at one or more buttons of the plurality of buttons of the drill bit comprises a respective amount of button material to be removed from each button of the plurality of buttons so that each button has a predetermined profile.

Aspect 6B: The system of claim 2B, wherein the determined amount of button material to be removed at one or more buttons of the plurality of buttons of the drill bit comprises a respective amount of button material to be removed from each button of the plurality of buttons, limited by at least one specification of the drill bit.

Aspect 7B: The system of claim 6B, wherein the specification of the drill bit comprises a minimum tolerated gauge diameter at which the drill bit is usable, wherein removal of the determined amount of button material is configured to retain a gauge diameter greater than or equal to the minimum tolerated gauge diameter, thereby permitting further use of the drill bit before the drill bit reaches the minimum tolerated gauge diameter.

Aspect 8B: The system of claim 6B, wherein the determined amount of button material to be removed at one or more buttons of the plurality of buttons of the drill bit is an equal amount to be removed from each button of the plurality of buttons.

Aspect 9B: The system of claim 6B, wherein the determined amount of button material to be removed at one or more buttons of the plurality of buttons of the drill bit varies for each button of the plurality of buttons.

Aspect 10B: The system of any one of claims 2B-9B, wherein the computing device is configured to determine the amount of button material to be removed at one or more buttons of the plurality of buttons by:
determining, based on the data associated with the face portion of the drill bit from the imaging device, portions of the bit corresponding to the plurality of buttons; and
determining an amount of material loss of each button of the at least one button due to wear.

Aspect 11B: The system of any one of claims 2B-10B, further comprising a drill bit sharpening apparatus in communication with the computing device, wherein the drill bit sharpening apparatus is configured to receive an output from the computing device that is indicative of the determined amount of button material to be removed at one or more buttons of the plurality of buttons of the drill bit.

Aspect 12B: The system of any one of aspects 1B-11B, wherein the computing device is further configured store the informational profile in a memory.

Aspect 13B: The system of claim 12B, wherein storing the informational profile comprises updating the stored informational profile based on the data associated with the face portion of the drill bit from the imaging device, wherein the stored informational profile includes geometric, wear, usage, and/or condition information.

Aspect 14B: The system of claim 12B or aspect 13B, wherein the computing device is configured to determine a three-dimensional representation of the face portion of the drill bit based at least in part on the at least one acquired image of the face portion of the drill bit, and wherein the computing device is further configured to determine or update the stored informational profile of the drill bit based upon the three-dimensional representation of the face portion of the drill bit.

Aspect 15B: The system of any one of aspects 12B-14B, wherein the informational profile is associated with an identifier that is indicative of an identity of the drill bit.

Aspect 16B: The system of claim 15B, wherein the identifier comprises a serial number associated with the drill bit.

Aspect 17B: The system of claim 15B, wherein the computing device is configured to provide, on a user interface, a menu for selecting the identifier.

Aspect 18B: The system of claim 15B, wherein the identifier is a machine-readable, the system further comprising a reader that is configured to detect the identifier.

Aspect 19B: The system of claim 18B, wherein the identifier is a radio frequency identifier (RFID) or an optically capturable code.

Aspect 20B: The system of claim 15B, wherein the identifier is associated with the geometry of the drill bit, wherein the computing device is configured to determine the identifier based on the data received from the imaging device.

Aspect 21B: The system of claim 20B, wherein the geometry of the drill bit comprises the locations and sizes of the plurality of buttons.

Aspect 22B: The system of claim 20B or 21B, wherein the computing device is configured to determine the identifier by comparing the data received from the imaging device to a previously acquired image or a model.

Aspect 23B: The system of any one of aspects 15B-22B, wherein computing device is configured to associate an image acquired by the imaging device as the identifier.

Aspect 24B: The system of claim 16, wherein the image scanner comprises a memory storing a plurality of three-dimensional representations associated with respective serial numbers of drill bits, and wherein the image scanner has a processor that is configured to determine a three-dimensional representation of the plurality of three-dimensional representations that corresponds to the detected serial number of the drill bit.

Aspect 25B: The system of any one of aspects 1B-24B, wherein the drill bit is a down-the-hole percussive bit or a top hammer bit.

Aspect 26B: The system of any one of aspects 1B-25B, wherein the data received from the imaging device comprises at least one image of the face portion of the drill bit, wherein the at least one image comprises at least one two-dimensional image, and wherein the imaging device comprises a camera.

Aspect 27B: The system of any one of aspects 1B-26B, wherein the data received from the imaging device comprises at least one image of the face portion of the drill bit, wherein the computing device is configured to:
receive the at least one image of the drill bit; and
determine, based at least in part on the acquired at least one image of the drill bit, a condition or attribute of the drill bit.

Aspect 28B: The system of any one of aspects 13B-27B, wherein the stored informational profile comprises wear-related volumetric loss, wherein the computing device is configured to further determine, based on the wear-related volumetric loss, a determined amount of button material to be removed at one or more buttons of the plurality of buttons of the drill bit.

Aspect 29B: The system of any one of aspects 12B-28B, wherein the stored informational profile of the drill bit comprises one or more failure codes, and, optionally, wherein the computing device is configured to associate the one or more failure codes with the drill bit.

Aspect 30B: The system of any one of aspects 2B-29B, wherein the computing device is configured to determine a need for subjecting the drill bit to a steel removal process, and wherein, optionally, the computing device is configured to determine the need and an extent for subjecting the drill bit to a steel removal process.

Aspect 31B: The system of any one of aspects 2B-30B, wherein, based on the data associated with the face portion of the drill bit from the imaging device, the computing device is configured to determine a gauge diameter of the drill bit after removal of the amount of button material to be removed at one or more buttons of the plurality of buttons of the drill bit, the system further comprising a marking apparatus that is in communication with the computing device and configured to receive an input from the computing device that is indicative of a determined gauge diameter of the drill bit, and wherein the marking apparatus is configured to apply a mark or color to the drill bit based on the determined gauge diameter of the drill bit.

Aspect 32B: The system of claim 31B, wherein the computing device is configured to associate the determined gauge diameter of the drill bit with an identity of the drill bit.

Aspect 33B: The system of any one of aspects 2B-32B, wherein the computing device is configured to determine a presence of one or more condition signatures within the at least one acquired image and/or the three dimensional representation of the drill bit, and wherein the one or more condition signatures are each indicative of a condition associated with information in the stored informational profile of the drill bit.

Aspect 34B: The system of claim 33B, wherein the one or more condition signatures are indicative of one or more of: broken buttons; lost or missing buttons; over-drilled buttons; portions of the bit body (that supports the buttons) contacting rock (or other formation material); insufficient rotation speed; excessive rotation speed; under drilling; or proper wear.

Aspect 35B: The system of claim 33B, wherein the computing device is configured to determine, based upon the one or more condition signatures and the at least one acquired image and/or the three-dimensional representation of the drill bit, characteristics of a previous drilling cycle of the drill bit.

Aspect 36B: The system of any one of aspects 1B-36B, further comprising a database in communication with a processor of the computing device, wherein the database comprises images of drill bits that have been classified into a plurality of classifications, wherein the computing device is configured to determine, based upon the at least one acquired image and a comparison to the images of the drill bits of the database, at least one conclusion associated with a previous drilling cycle using the drill bit.

Aspect 37B: The system of claim 36B, wherein the plurality of classifications comprise a properly run drill bit and an improperly run drill bit, wherein the conclusion comprises a determination as to whether the drill bit was run properly or improperly.

Aspect 38B: The system of any one of aspects 1B-37B, further comprising a database in communication with a processor of the computing device, wherein the computing device is configured to store the informational profile of the drill bit, the informational profile of the drill bit comprising the at least one acquired image.

Aspect 39B: The system of claim 38, wherein the computing device is configured to update the database to include, for each drill bit of a plurality of drill bits, searchable data indicative of the usage, wear, condition, and/or structure of the drill bit, acquired images of the drill bit, and/or an assigned category of the drill bit.

Aspect 40B: The system of any one of aspects 2B-39B, further comprising a robot that is in communication with the computing device, the robot having a robotic arm that is coupled to the imaging device, wherein the computing is configured to cause the robotic arm to move the imaging device in a pattern that permits acquisition of at least one image of the drill bit by the imaging device.

Aspect 41B: The system of claim 40B, further comprising a robotic arm that is in communication with the computing device and coupled to the drill bit sharpening apparatus, wherein the computing device is configured to cause the robotic arm to move the drill bit sharpening apparatus in a pattern that permits removal of the determined amount of button material of each button of the plurality of buttons.

Aspect 42B: The system of any one of aspects 1B-41B, wherein the computing device is configured to associate a serial number of the drill bit with drill bit condition information and to update the drill bit condition information, wherein the drill bit condition information includes one or more of: number of sharpenings; current gauge diameter; damage progression; usage evaluation of previous run of the drill bit; usage evaluation of complete life of the drill bit.

Aspect 43B: The system of claim 42, wherein the computing device is configured to associate, with the drill bit condition information, one or more of: drilled distance per run; total drilled distance, average rate of penetration, hours of active drilling, type or characteristics of the rock drilled, location of drilling, time of operation, shift of operation, identification of a drill rig used with the drill bit, or identification of a driller operating the drill bit.

Aspect 1C: A system comprising:
a scanner that is configured to capture a 3D profile of a drill bit;
a computing device in communication with the scanner, the computing device comprising logic that is configured to:
   identify buttons on the drill bit; and
   determine an amount of carbide loss of the buttons of the drill bit; and
a bit grinder in communication with the computing device, wherein the computing device is configured to receive an output from the computing device associated with the determined carbide loss of the buttons, and wherein the bit grinder is configured to recondition the drill bit based on the output from the computing device associated with the determined carbide loss of the buttons.

Although the foregoing invention has been described in some detail by way of illustration and example for purposes of clarity of understanding, certain changes and modifications may be practiced within the scope of the appended claims.

What is claimed is:

1. A system comprising:
an imaging device configured to acquire data associated with a face portion of a drill bit, the face portion of the drill bit having a face surface and a plurality of buttons projecting from the face surface; and
a computing device in communication with the imaging device,
wherein the computing device is configured to:
receive data associated with the face portion of the drill bit from the imaging device;
determine, based on the data received from the imaging device, an informational profile of the face portion of the drill bit, wherein the informational profile includes geometric, wear, usage, and/or condition information.

2. The system of claim 1, wherein the informational profile of the face portion of the drill bit comprises wear-related volumetric loss, wherein the computing device is configured to further determine, based on the wear-related volumetric loss, an amount of button material to be removed at one or more buttons of the plurality of buttons of the drill bit.

3. The system of claim 2, wherein the data received from the imaging device comprises at least one image of the face portion of the drill bit.

4. The system of claim 3, wherein the imaging device comprises an image scanner, wherein the at least one image of the drill bit comprises a 3D scan of the face portion of the drill bit.

5. The system of claim 2, wherein the determined amount of button material to be removed at one or more buttons of the plurality of buttons of the drill bit comprises a respective amount of button material to be removed from each button of the plurality of buttons so that each button has a predetermined profile.

6. The system of claim 2, wherein the determined amount of button material to be removed at one or more buttons of the plurality of buttons of the drill bit comprises a respective amount of button material to be removed from each button of the plurality of buttons, limited by at least one specification of the drill bit.

7. The system of claim 6, wherein the specification of the drill bit comprises a minimum tolerated gauge diameter at which the drill bit is usable, wherein removal of the determined amount of button material is configured to retain a gauge diameter greater than or equal to the minimum tolerated gauge diameter, thereby permitting further use of the drill bit before the drill bit reaches the minimum tolerated gauge diameter.

8. (canceled)

9. (canceled)

10. The system of claim 2, wherein the computing device is configured to determine the amount of button material to be removed at one or more buttons of the plurality of buttons by:
determining, based on the data associated with the face portion of the drill bit from the imaging device, portions of the bit corresponding to the plurality of buttons; and
determining an amount of material loss of each button of the at least one button due to wear.

11. The system of claim 2, further comprising a drill bit sharpening apparatus in communication with the computing device, wherein the drill bit sharpening apparatus is configured to receive an output from the computing device that is indicative of the determined amount of button material to be removed at one or more buttons of the plurality of buttons of the drill bit.

12. The system of claim 1, wherein the computing device is further configured store the informational profile in a memory.

13. The system of claim 12, wherein storing the informational profile comprises updating the stored informational profile based on the data associated with the face portion of the drill bit from the imaging device, wherein the stored informational profile includes geometric, wear, usage, and/or condition information.

14. The system of claim 12, wherein the computing device is configured to determine a three-dimensional representation of the face portion of the drill bit based at least in part on the at least one acquired image of the face portion of the drill bit, and wherein the computing device is further configured to determine or update the stored informational profile of the drill bit based upon the three-dimensional representation of the face portion of the drill bit.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. The system of claim 1, wherein the data received from the imaging device comprises at least one image of the face portion of the drill bit, wherein the computing device is configured to:
receive the at least one image of the drill bit; and
determine, based at least in part on the acquired at least one image of the drill bit, a condition or attribute of the drill bit.

28. The system of claim 13, wherein the stored informational profile comprises wear-related volumetric loss, wherein the computing device is configured to further determine, based on the wear-related volumetric loss, a determined amount of button material to be removed at one or more buttons of the plurality of buttons of the drill bit.

29. (canceled)

30. The system of claim 2, wherein the computing device is configured to determine a need for subjecting the drill bit to a steel removal process, and

31. The system of claim 2, wherein, based on the data associated with the face portion of the drill bit from the imaging device, the computing device is configured to determine a gauge diameter of the drill bit after removal of the amount of button material to be removed at one or more buttons of the plurality of buttons of the drill bit, the system further comprising a marking apparatus that is in communication with the computing device and configured to receive an input from the computing device that is indicative of a determined gauge diameter of the drill bit, and wherein the marking apparatus is configured to apply a mark or color to the drill bit based on the determined gauge diameter of the drill bit.

32. The system of claim 31, wherein the computing device is configured to associate the determined gauge diameter of the drill bit with an identity of the drill bit.

33. (canceled)

34. (canceled)

35. (canceled)

36. (canceled)

37. (canceled)

38. (canceled)

39. (canceled)

40. The system of claim 2, further comprising a robot that is in communication with the computing device, the robot having a robotic arm that is coupled to the imaging device, wherein the computing is configured to cause the robotic arm to move the imaging device in a pattern that permits acquisition of at least one image of the drill bit by the imaging device.

41. The system of claim 40, further comprising a robotic arm that is in communication with the computing device and coupled to the drill bit sharpening apparatus, wherein the computing device is configured to cause the robotic arm to move the drill bit sharpening apparatus in a pattern that permits removal of the determined amount of button material of each button of the plurality of buttons.

42. The system of claim 1, wherein the computing device is configured to associate a serial number of the drill bit with drill bit condition information and to update the drill bit condition information, wherein the drill bit condition information includes one or more of: number of sharpenings; current gauge diameter; damage progression; usage evaluation of previous run of the drill bit; usage evaluation of complete life of the drill bit.

43. (canceled)
